(19) United States
(12) Patent Application Publication
(10) Pub. No.: US 2011/0209074 A1
(43) Pub. Date: Aug. 25, 2011

(54) ROTATING ANIMATED VISUAL USER DISPLAY INTERFACE

(76) Inventors: George M. GILL, Vilonia, AR (US); Joel A. Kunert, Maumelle, AR (US); Rajani K. Pulapa, Little Rock, AR (US); Stephen K. Rigsby, Conway, AR (US)

(21) Appl. No.: 13/021,469

(22) Filed: Feb. 4, 2011

Related U.S. Application Data
(60) Provisional application No. 61/301,349, filed on Feb. 4, 2010.

(51) Int. Cl. G06F 3/048

(52) U.S. Cl. 715/760; 715/771

(57) ABSTRACT

A computer-implemented method, system, and medium is provided for performing vehicle service activities. Embodiments include displaying, on a first portion of a display unit, a plurality of visual images, each visual image corresponding to a respective one of the vehicle service activities, arranged along a movement path. In response to a selection of a first visual image of the plurality of visual images, a user interface is displayed on a second portion of the display unit for performing the vehicle service activity corresponding to the first visual image, a visual indication for the first visual image that it was selected is displayed on the first portion of the display unit, and at least one of the plurality of visual images moves along the movement path in response to the selection.

### RELATED APPLICATION

The present invention claims priority of provisional patent application No. 61/301,349 filed Feb. 4, 2010, the contents of which are incorporated herein in their entirety.

### TECHNICAL FIELD

The present subject matter relates to automotive vehicle service equipment. The present subject matter has particular applicability to user interfaces for wheel alignment equipment.

### BACKGROUND

A current conventional vehicle wheel alignment system uses sensors or heads that are attached to the wheels of a vehicle to measure various angles of the wheels and suspension. These angles are communicated to a host system, where they are used in the calculation of vehicle alignment angles. In the standard conventional aligner configuration, four alignment heads are attached to the wheels of a vehicle. Each sensor head comprises two horizontal or toe measurement sensors and two vertical or camber/pitch sensors. Each sensor head also contains electronics to support overall sensor data acquisition as well as communications with the aligner console, local user input, and local display for status feedback, diagnostics and calibration support.

In recent years, wheels of motor vehicles have been aligned in some shops using a computer-aided, three-dimensional (3D) machine vision alignment system. In such a system, one or more cameras view targets attached to the wheels of the vehicle, and a computer in the alignment system analyzes the images of the targets to determine wheel position and alignment of the vehicle wheels from the wheel position data. The computer typically guides an operator to properly adjust the wheels for precise alignment, based on calculations obtained from processing of the image data. A wheel alignment system or aligner of this image processing type is sometimes called a “3D aligner.” Examples of methods and apparatus involving computerized image processing for alignment of motor vehicles are described in U.S. Pat. No. 5,943,783 entitled “Method and apparatus for determining the alignment of motor vehicle wheels;” U.S. Pat. No. 5,809,658 entitled “Method and apparatus for calibrating cameras used in the alignment of motor vehicle wheels;” U.S. Pat. No. 5,724,743 entitled “Method and apparatus for determining the alignment of motor vehicle wheels;” and U.S. Pat. No. 5,535,522 entitled “Method and apparatus for determining the alignment of motor vehicle wheels.” A wheel alignment system of the type described in these references is sometimes called a “3D aligner” or “visual aligner.” An example of a commercial vehicle wheel aligner is the Visualiner 3D, commercially available from John Bean Company of Conway, Ark., a unit of Snap-on Inc.

Alternatively, a machine vision wheel alignment system may include a pair of passive heads and a pair of active sensing heads. The passive heads are for mounting on a first pair of wheels of a vehicle to be measured, and the active sensing heads are for mounting on a second pair of wheels of the vehicle. Each passive head includes a target, and each active sensing head includes gravity gauges for measuring caster and camber, and an image sensor for producing image data, including an image of a target of one of the passive heads, when the various heads are mounted on the respective wheels of the vehicle. The system also includes a spatial relationship sensor associated with at least one of the active sensing heads, to enable measurement of the spatial relationship between the active sensing heads when the active sensing heads are mounted on wheels of the vehicle. The system further includes a computer for processing the image data relating to observation of the targets, as well as positional data from the spatial relationship sensor, for computation of at least one measurement of the vehicle.

A common feature of all the above-described alignment systems is that a computer guides an operator to properly adjust the wheels for precise alignment, based on calculations obtained from processing of the sensor data. These systems therefore include a host computer having a user interface such as a display screen, keyboard, and mouse. Typically, the user interface employs graphics to aid the user, including depictions of the positions of the vehicle wheels, representations of analog gauges with pointers and numbers, etc. The more intuitive, clear, and informative such graphics are, the easier it is for the user to perform an alignment quickly and accurately. There exists a need for an alignment system user interface that enables the user to reduce the time needed to perform an alignment, and enables the user to perform the alignment more accurately.

Additionally, alignment shops typically store and/or have access to many different databases containing information of interest to the user of an alignment system. Such information includes data relating to the particular vehicle being aligned and/or its owner, and other similar vehicles that have been serviced by the shop. This information further includes vehicle manufacturers' technical data, data relating to vehicle parts provided by parts manufacturers, and instructional data. There exists a need for an alignment system user interface that presents technical information and individual vehicle information to the user on demand, in a desired format, to improve efficiency and accuracy.

### SUMMARY

The teachings herein improve over conventional alignment equipment by providing an improved user interface that enables a user to perform a vehicle alignment more quickly and accurately, thereby reducing costs.

According to the present disclosure, the foregoing and other advantages are achieved in part by a computer-implemented method for performing a plurality of vehicle service activities. The method comprises displaying, on a first portion of a display unit, a plurality of visual images, each visual image corresponding to a respective one of the vehicle service activities, arranged along a movement path; receiving a first selection of a first visual image included in the visual images; displaying, on a second portion of the display unit, a user interface for performing the vehicle service activity corresponding to the first visual image, in response to the first selection; displaying the visual indication for the first visual image that the first visual image was selected, in response to the first selection; and moving at least one of the plurality of visual images along the movement path in response to the first selection.

In accord with another aspect of the disclosure, a vehicle service system for performing a vehicle service activity comprising a series of service activities comprises a processor; and a computer readable medium having computer-executable instructions that, when executed by the processor, cause the computer system to: display, on a first portion of a display unit, a plurality of visual images, each visual image corresponding to a respective one of the vehicle service activities, arranged along a movement path; receive a first selection of a first visual image included in the visual images; display, on a second portion of the display unit, a user interface for performing the vehicle service activity corresponding to the first visual image, in response to the first selection; display the visual indication for the first visual image that the first visual image was selected, in response to the first selection; and move at least one of the plurality of visual images along the movement path in response to the first selection.

In accord with yet another aspect of the disclosure, a computer readable medium has instructions for performing a vehicle service activity comprising a series of service steps that, when executed by a computer system, cause the computer system to: display, on a first portion of a display unit, a plurality of visual images, each visual image corresponding to a respective one of the vehicle service activities, arranged along a movement path; receive a first selection of a first visual image included in the visual images; display, on a second portion of the display unit, a user interface for performing the vehicle service activity corresponding to the first visual image, in response to the first selection; display the visual indication for the first visual image that the first visual image was selected, in response to the first selection; and move at least one of the plurality of visual images along the movement path in response to the first selection.

Additional advantages and novel features will be set forth in part in the description which follows and in part will become apparent to those having ordinary skill in the art upon examination of the following and the accompanying drawings or may be learned from production or operation of the examples. The advantages of the present teachings may be realized and attained by practice or use of the methodologies, instrumentalities and combinations particularly pointed out in the appended claims.

### BRIEF DESCRIPTION OF THE DRAWINGS

Reference is made to the attached drawings, wherein elements having the same reference numeral designations represent like elements throughout, and wherein:

FIG. 1 depicts an exemplary architecture of a system in which the disclosed graphical user interface is implemented.

FIG. 2a schematically shows a user interface display screen featuring a carousel control according embodiments of the present disclosure.

FIG. 2b is a flow chart of an exemplary process for implementing the carousel control of the present disclosure.

FIGS. 2c-e are exemplary screen shots of the carousel control user interface according to embodiments of the present disclosure.

FIG. 3a is a flow chart of an exemplary process for implementing a user interface with nested controls according to the present disclosure.

FIGS. 3b-f are exemplary screen shots of a user interface with nested controls according to embodiments of the present disclosure.

FIGS. 4a-b are exemplary screen shots of dynamic drop down windows according to embodiments of the present disclosure.

FIG. 5 is an exemplary screen shot of a floating window according to embodiments of the present disclosure.

FIGS. 6a-b are exemplary screen shots of transparent pop up window backgrounds according to embodiments of the present disclosure.

FIGS. 7a-b show exemplary windows with gradient background fill according to embodiments of the present disclosure.

FIGS. 8a-c are exemplary screen shots of dashboard indicators according to embodiments of the present disclosure.

FIGS. 9a-11h are exemplary screen shots of user interface graphics according to embodiments of the present disclosure.

FIGS. 12a-b are exemplary screen shots of XSLT transformed documents incorporated into the user interface of embodiments of the present disclosure.

FIG. 13 shows a report generated according to embodiments of the present disclosure.

FIG. 14 depicts a general computer architecture on which the present disclosure can be implemented.

### DETAILED DESCRIPTION

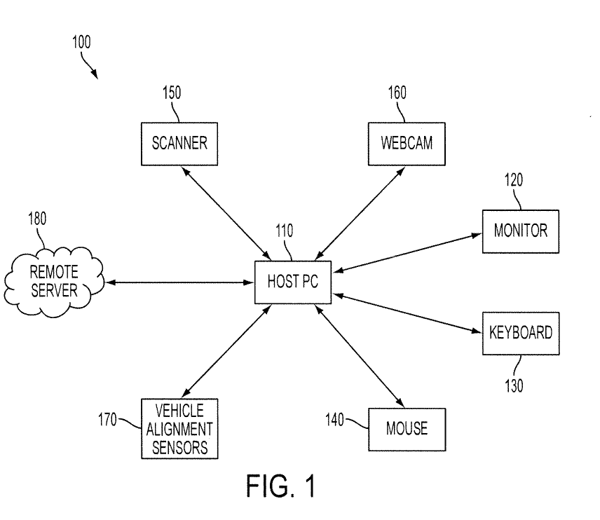

FIG. 1 is an exemplary architecture of a system 100 that is an environment for implementing the user interface of the present disclosure. In system 100, a host computer, such as a commercially available personal computer (PC) 110, is connected to conventional input and output devices such as monitor 120, keyboard 130, mouse 140, scanner 150, and webcam 160. Monitor 120 is a conventional monitor, or a conventional touch screen for accepting user input. PC 110 is further connected to vehicle alignment sensors 170 of a vehicle wheel alignment system as discussed in the “Background” section herein above. A conventional remote server 180 is also connected to host PC 110. Server 180 provides content from various databases described herein to PC 110. Such content is either stored at server 180, or obtained via the Internet or another remote data network. PC 110 can also send data to server 180; for example, to update certain databases stored at server 180.

Several examples of graphic user interfaces according to the present disclosure will now be described with reference to the drawings.

Carousel Control

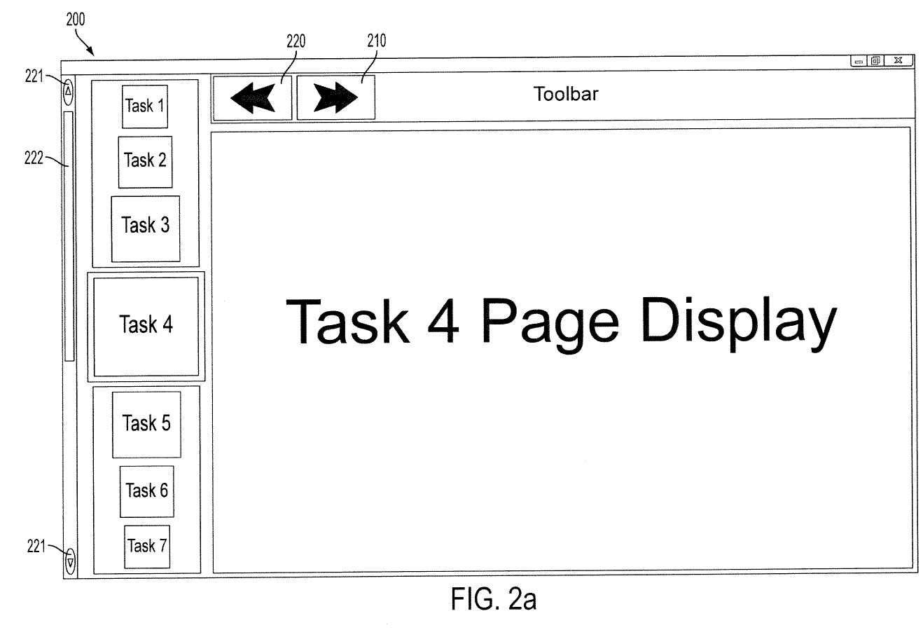

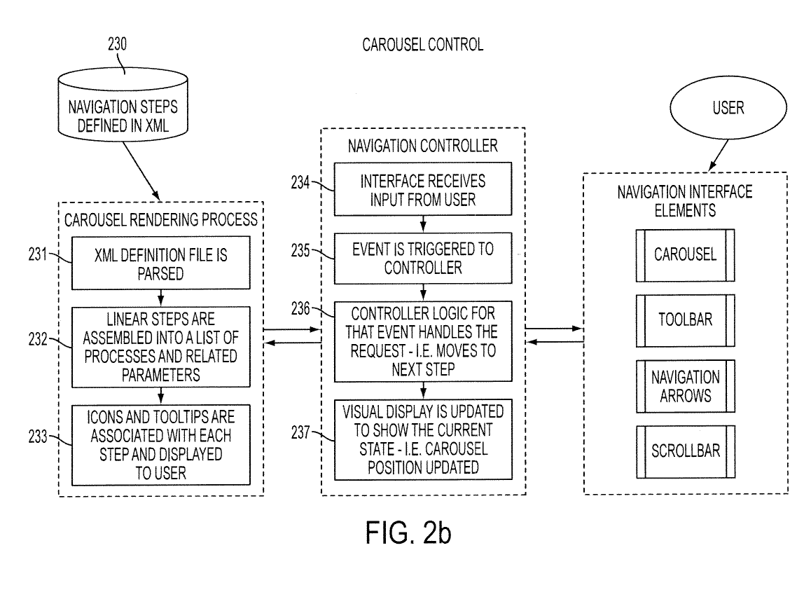

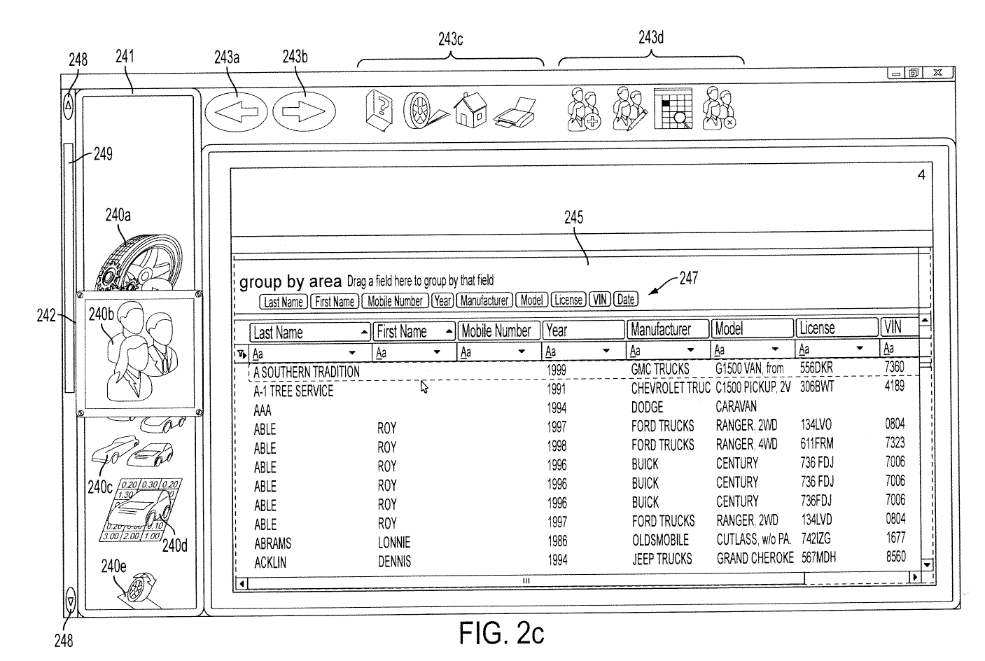

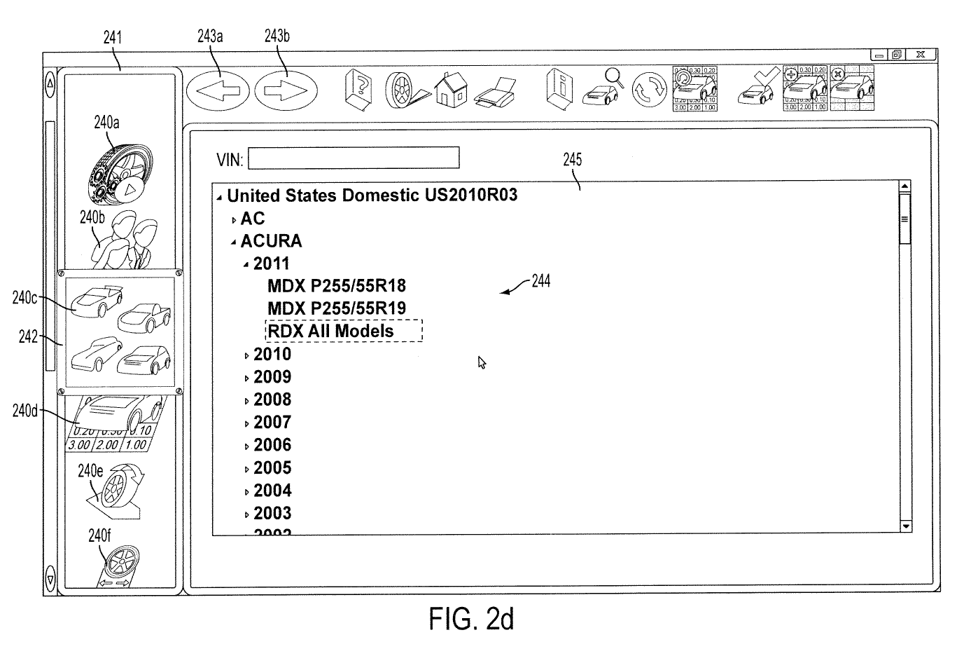

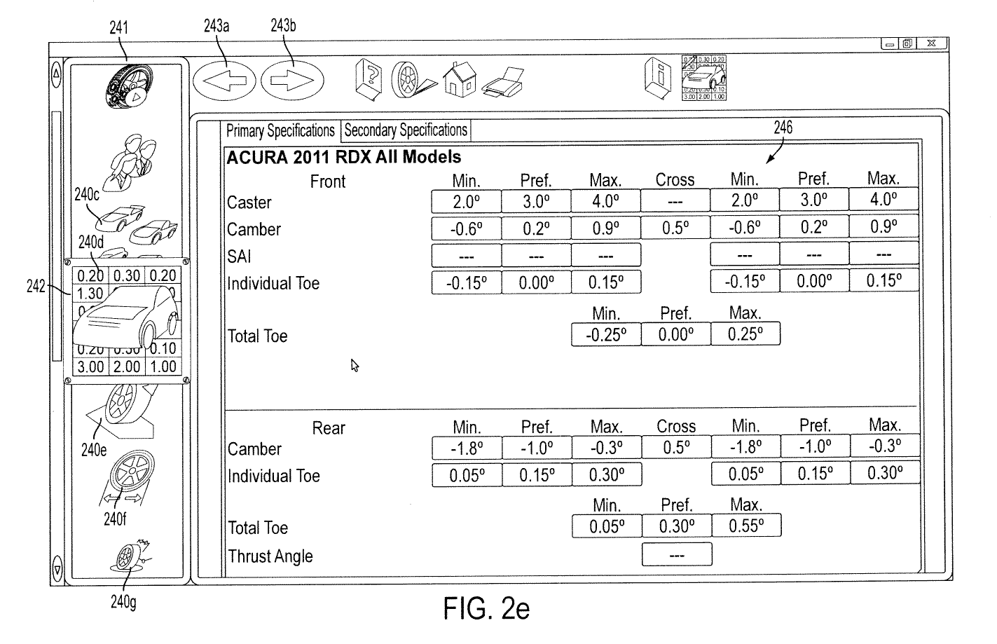

In an embodiment of the present disclosure shown in FIGS. 2a-e, a process or menu is displayed in a rotating animated list or “carousel,” similar to a list box. Individual icons slide along a predefined path and change in appearance and orientation along the path to show which item has focus, as if on an invisible conveyor belt. These visual effects provide the user a sense of depth and/or motion, by affecting the transparency, scale, and skew of objects as they move into and out of the user's focus.

Referring now to FIG. 2a, a plurality of icons representing tasks 1-7 are shown vertically on the left side of screen 200. Additional tasks, if any, are off the screen 200 in the queue. If the task icons represent sequential steps in a process, the process is advanced through each task by clicking on the right arrow 210 at the top of the screen 200, and is reversed by clicking on the left arrow 220 at the top of the screen 200. Navigation among the tasks can also be performed by clicking on the icon of the desired task in the carousel. For example, in FIG. 2a, the user can click on task 6 and bypass task 5. As the process advances or retreats, the icons are animated along a movement path so that the current task moves, e.g., to the center of the carousel and its appearance changes, while other task icons move with it and are visible to the user.

In FIG. 2a, Task 4 is currently the active task, and the central part of the screen 200 displays details of task 4 (i.e., instructions, readings, data entry/selection, etc.). The user could also use the scroll buttons 221 or the scroll bar 222 to scroll to a task icon in the carousel not shown in FIG. 2a, if the user wanted to skip ahead or back in the process. As previously discussed, the icons move so that the current task is in the central part of the carousel, while the tasks immediately ahead of it and behind it are visible in the carousel.

In certain embodiments, the task icons 1-7 represent different processes available to the user (e.g., calibration, regular alignment, quick alignment, etc.) rather than steps in a process. Such a display could be the “home” display presented to the user when the system is first started up, or when the user clicks a “home” icon. In this case, clicking on a task icon brings up a new set of icons in the carousel representing the steps of the selected process.

Implementation of the disclosed carousel control in a user interface is diagrammed in FIG. 2b. The process flow of the carousel's navigation steps are defined in a document in a well-known language such as XML (Extensible Markup Language) 230. During the carousel rendering process, the XML definition file is parsed at step 231, and linear steps are assembled into a list of processes and related parameters at step 232. Icons and tooltips are associated with each step and displayed to the user at step 233. In step 234, the interface receives input from the user via the carousel display, the toolbar, navigation arrows, or a scrollbar. This user input triggers an event in the controller at step 235, and the controller logic for that event translates the event and performs the desired action at step 236. The visual display screen is then updated at step 237 to show the current state; i.e., the carousel position is updated. The carousel control of this embodiment is implemented with commercially available software such as Infragistics Net Advantage available at www.infragistics.com.

The operation of the carousel control in the context of performing a vehicle service such as a wheel alignment comprising a series of service activities will now be described with reference to FIGS. 2c-e. As shown in FIG. 2c, a plurality of visual images (e.g., icons) 240a-e is displayed on a first portion 241 of a display unit, each visual image 240a-e corresponding to a respective one of the service activities. For example, 240b represents the customer data entry step, 240c represents the vehicle selection step, 240d represents the vehicle specifications step, etc. The visual images 240a-e are displayed along a movement path and are ordered corresponding to the sequence in which their respective service activities are arranged. A visual indication 242 (e.g., a box around the visual image or an illumination effect for the visual image, along with an increased size of the visual image) that the service activity corresponding to a visual image 240b is being performed is displayed. In this example, not all the visual images 240a-g are shown on the screen at once. In FIG. 2c, only images 240a-e are shown, while images 240f and g are not shown. The visual images 240a-g are displayed linearly in the embodiment of FIGS. 2c-e, but could be displayed using another arrangement.

A first selection by the user of a first visual image 240c is received from one of a number of displayed user interface elements; for example, by the user mouse-clicking or touching one of the “previous” or “next” arrows 243a, 243b, or one of the icons 240a-e. The user could also use the scroll buttons 248 or the scroll bar 249 to scroll to a visual image in the carousel not shown in FIG. 2c; for example, to visual image 240f or 240g of FIGS. 2d and 2e, respectively, if the user wanted to skip ahead in the process.

As shown in FIG. 2d, in response to the first selection, a user interface 244 for performing the service activity corresponding to the first visual image 240c is displayed on a second portion of the display unit 245, while the display in the first portion of the display unit 241 moves to show the visual images 240a-f. Note the visual images have scrolled upward so the selected image 240c is in a central part of portion 241. Also in response to the first selection, the visual indication 242 (the box or illumination effect and the larger size) is displayed for the first visual image 240c.

In certain embodiments, a visual indication for a second visual image is displayed indicating that the service step corresponding to the second visual image has been completed. In other embodiments, such as shown in FIG. 2a, each of the plurality of visual images (boxes labeled Tasks 1-7) is scaled such that there is an inverse relationship between the scale applied to a visual image and the distance of the visual image from the second visual image (which is analogous to Task 4), in response to the first selection. Thus, in FIG. 2a, the task icons get smaller the farther they are from the selected task.

In a further example referring to FIGS. 2d-e, a second selection is received wherein the user clicks on or touches the “next” arrow 243b or next icon 240d. In response to the second selection as shown in FIG. 2e, the system identifies a second service activity (i.e., the step corresponding to icon 240d) in the series of service activities immediately after the service activity currently being performed, and displays a user interface 246 for performing the second service activity on the second portion 245 of the display unit, the display in the first portion 241 of the display unit moves up to show visual images 240a-g, and displays a visual indication 242 for the visual image 240d that the second service activity is being performed. Note also the visual images have scrolled upward so the selected image 240d is in a central part of portion 241, and image 240g now appears.

Referring again to FIG. 2d, if a third selection is received wherein the user clicks on or touches the “previous” arrow 243a or previous icon 240b, the system in response identifies a third service activity (i.e., the activity corresponding to icon 240b) in the series of service activities immediately before the service activity currently being performed. Referring now to FIG. 2c, a user interface 247 for performing the third service activity is displayed on the second portion 245 of the display unit while displaying the plurality of visual images 240a-e in the first portion 241 of the display unit, and a visual indication 242 that the service step is being performed is displayed for the visual image 240b. Also, the visual images scroll downward so the selected image 240b is in a central part of portion 241, and the image 240f is now excluded from the screen.

Note that the group of icons 243c next to the arrows 243a-b are utilities such as Help, Home, Print, etc. and always appear on every screen, while the group of icons 243d to the right of group 243c are specific to the task being displayed, and change from one task to another.

The disclosed carousel control is advantageous over conventional user interfaces typically found in alignment systems, wherein the user must proceed through the tasks in a linear fashion. In such systems, there is no visual reference to indicate which tasks have been performed, or what task will be performed in the next step. With the disclosed carousel control, the user can choose to proceed linearly through the tasks, or randomly access individual tasks of the ongoing process. Moreover, each task icon of the carousel can bear a visual indication of whether or not it has been performed. Thus, the disclosed carousel control gives dimension and perspective to enhance the user's focus on the immediate task(s), while simultaneously enabling the user to see tasks that have been or will be performed.

Nested User Interface Elements

Software elements such as tooltips, combo boxes, list boxes, etc. are a common part of personal computer user interfaces. For example, tooltips typically appear as simple text-based popup controls containing contextual information when a mouse pointer is placed over a certain location or other visual component within the active program. Combo boxes usually have a text box displaying a single text value, and an expander arrow to indicate there is list available for display.

In a further embodiment of the disclosure, such software elements are enhanced by nesting controls within other controls and by adding graphics, to provide a large amount of information without cluttering a screen already having many visual components. Also, this embodiment facilitates localization, reduces the effort for text translations, and improves efficiency of navigation of the interface.

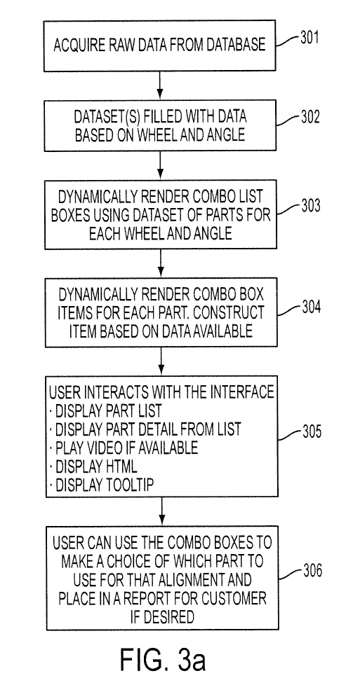

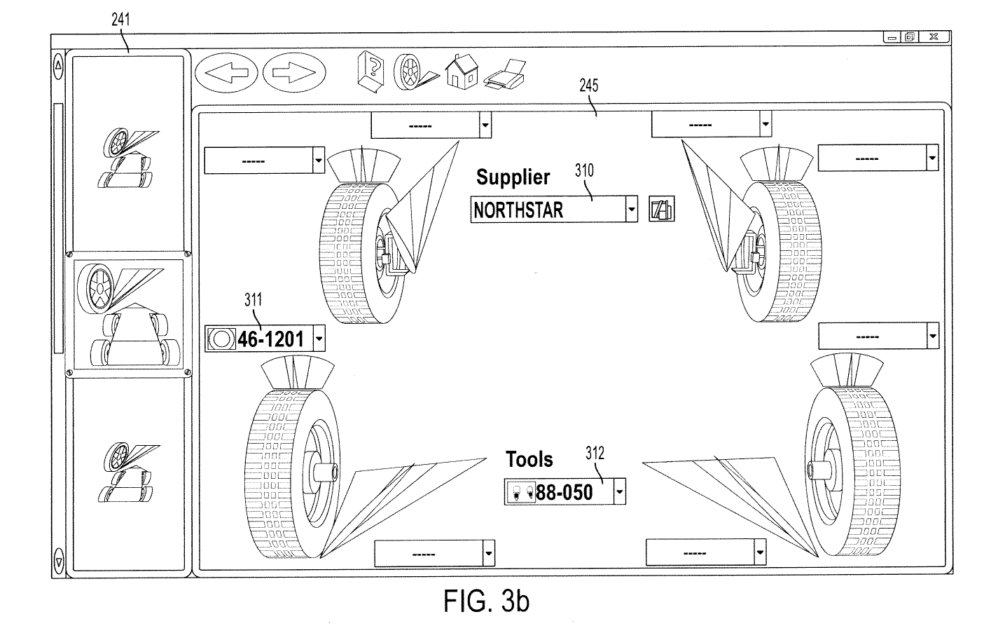

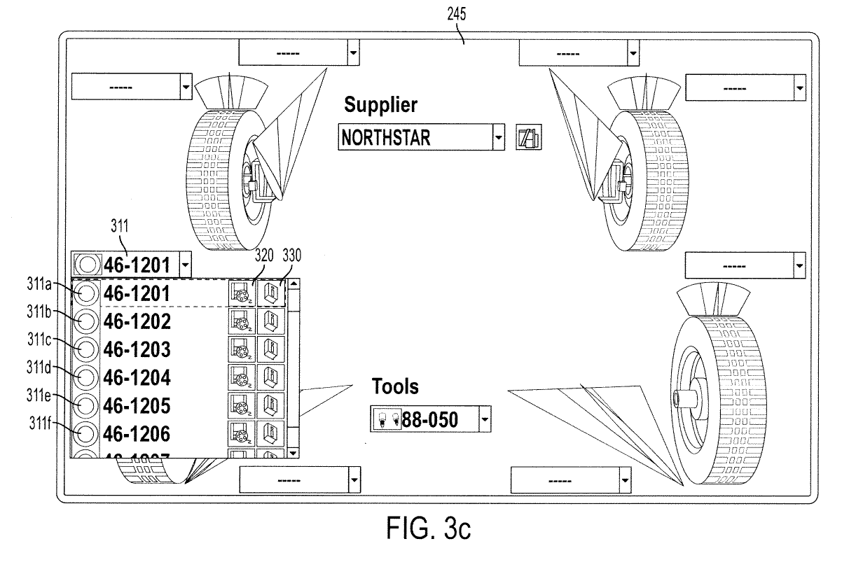

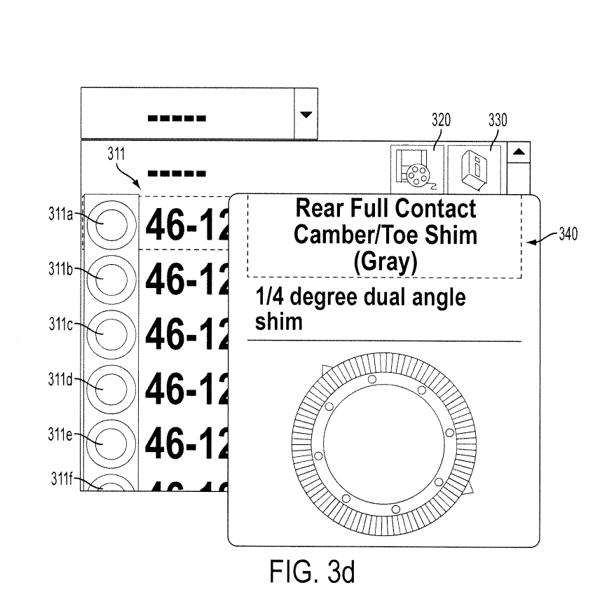

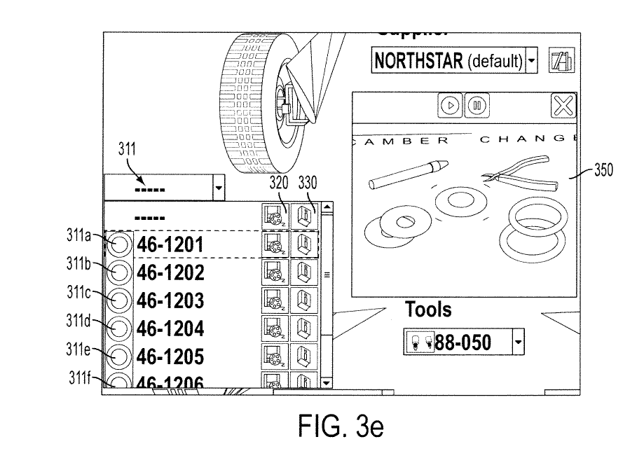

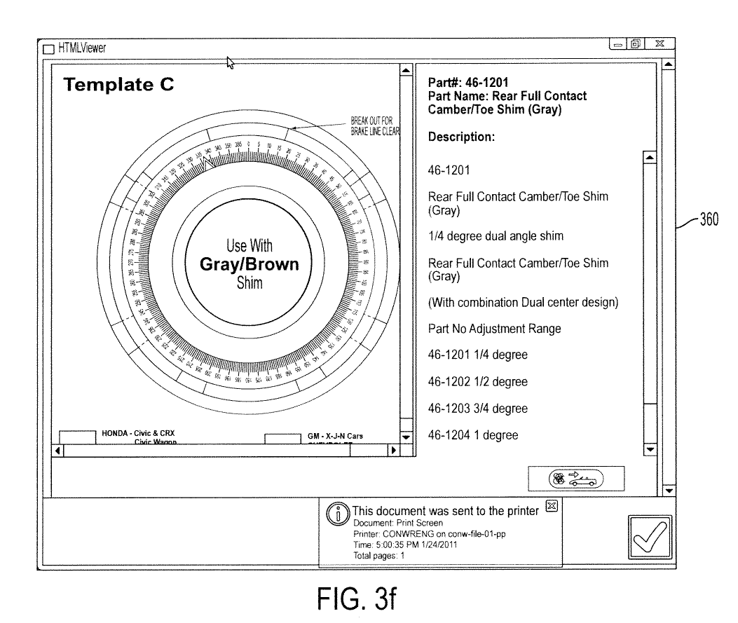

Referring now to FIGS. 3a-f, the alignment technician is provided an interface that displays aftermarket parts specific to a vehicle model and even to a particular axle and/or suspension angle, to aid the technician in viewing, evaluating, and selecting parts for a specific wheel and angle of the vehicle, to facilitate the adjustment of alignment angles. The user selects a list of part numbers from a combo box for each location. While a conventional interface typically provides only a list of text-based part numbers, this embodiment provides an image thumbnail, a part number, part specifications, a button to display a video clip of installing the part(s), and a button to link to a page displaying installation instructions.

The above features are implemented by embedding visual elements within other visual elements and by using data templating having the flexibility to customize the data presentation process. According to this embodiment, an aftermarket parts database is queried for part information, and the details of that part are used to construct a combo box for each wheel and angle to be adjusted/checked. The combo box is dynamically populated with more than simply a text description of a part. It is embedded with a thumbnail graphic that can also invoke a tooltip, which in turn is composed of a number of elements such as a larger graphic, a detailed description of the part, etc. In certain embodiments, the combo box contains several buttons for each list item, which are used to invoke other events, such as a video of a part, an HTML page having the part specifications, adjustment guide(s) for using the part, etc.

Implementation of the disclosed nested user interface elements is diagrammed in FIG. 3a. At step 301, raw data is queried from a database, such as an aftermarket parts database, responsive to a selected vehicle. At step 302, the data is arranged into datasets for each wheel and angle. The user interface is then rendered at step 303 by dynamically rendering combo list boxes using the datasets of parts for each wheel and angle, and at step 304 by dynamically rendering the combo box items (for each part, an item is constructed based on the available data). Basic controls are embedded by defining a data template, to provide flexibility in the presentation of data. In this step, visual elements are “bound” to corresponding datasets to display the desired data for each wheel and angle.

In step 305, the user interacts with the interface to display a part list, display part details from the list, and to play a video, display an HTML document, or display a tooltip as desired. The user thus employs the combo boxes to choose which part to use for a particular alignment operation, and can create a report for their customer (see step 306).

The operation of the nested user control interface elements in the context of performing a vehicle service such as a wheel alignment will now be described with reference to FIGS. 3b-f, which show the disclosure of this embodiment in the context of the carousel control discussed herein above. The carousel control is easily used with the nested controls of this embodiment, as the nested controls are part of the user interface in the second portion 245 of the display unit. As shown in FIG. 3b, a vehicle measurement user interface in portion 245 of the display unit displays user interface elements 310-312 in the form of pulldown menus for listing a plurality of items. The shim supplier “Northstar” is chosen in the “Supplier” field 310. Another pulldown menu 311 is indicated where the specific shim part number can be selected, and yet another pulldown menu 312 is indicated in the “Tools” field, where the tools needed to perform the job can be shown. The user interface element is not limited to a pulldown menu, but could also be a combo box, list box, dropdown list, or a combination thereof.

FIG. 3c shows the result of a first selection of the pulldown indicator of a first user interface element 311, as by a mouse click, by touching a touch screen, or by hovering the mouse cursor over the “46-1201” field. The first user interface element 311 is displayed, along with a listing of a plurality of items 311a-f in response to the first selection (in this example, a list of part numbers). Each item 311a-f is presented with a second user interface element 320 and a third user interface element 330, in this case icons. In certain embodiments, hovering over an item such as 311a will also bring up a tooltip with a visual display. For example, as shown in FIG. 3d, element 340 is a visual display of a shim with its description.

Referring now to FIG. 3e, a second selection, for the second user interface element 320, is received for the first item 311a. In response to the second selection, at least a portion of the listing of the plurality of items 311a-f is displayed, along with a fourth user interface element 350 including contents relating to the first item. In this example, element 320 is an animation icon, and element 350 is a video displayed in a pop up window showing how to install the part.

Referring now to FIG. 3f, if a third selection, for the third user interface element 330, is received for the first item 311a, the displayed listing of the plurality of items 311a-e is removed, and the display 360 communicates that the first item 311a was selected in response to the third selection. In this example, element 330 is an information icon, and display 360 gives detailed information about the selected part.

By building complex controls and embedding varying interface elements, more information is provided to the user with easier and more efficient navigation. This embodiment can be implemented, for example, by defining a resource in the WPF/XAML file which creates a customized tooltip content, as by defining a stack panel control containing a label, a text block, and an image.

Dynamic Drop Down Windows

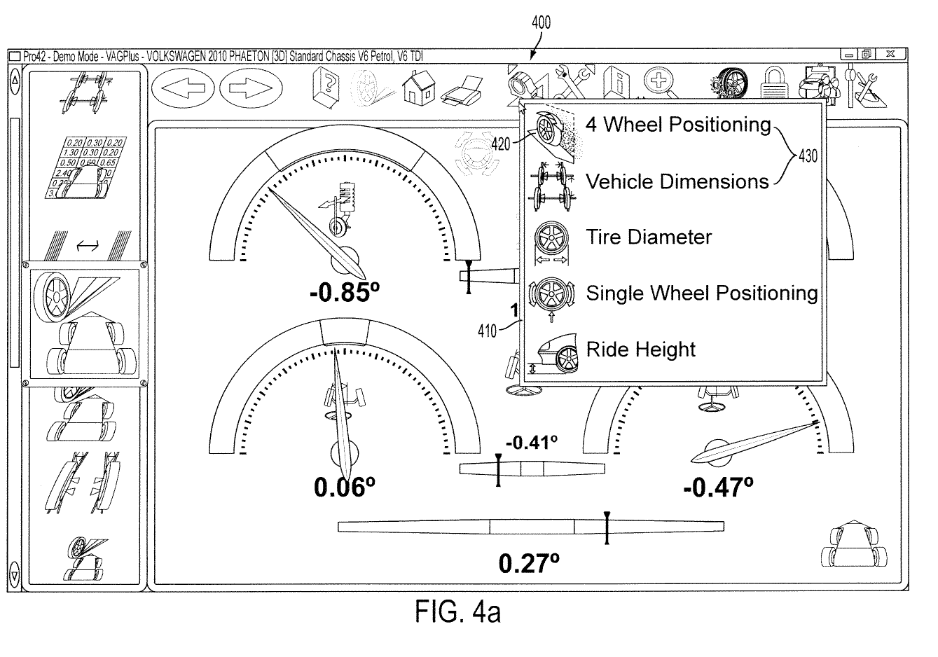

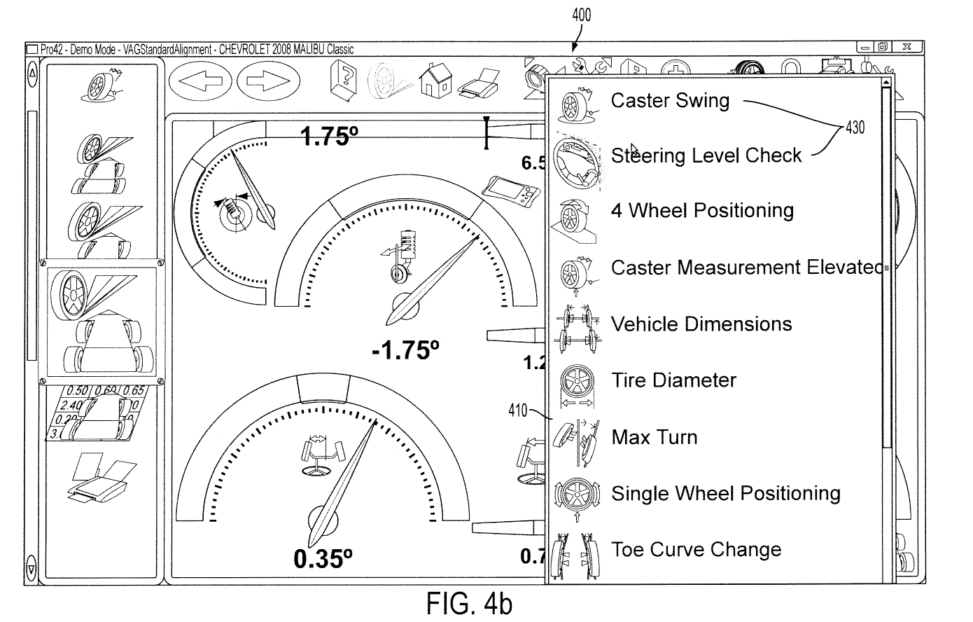

In certain embodiments of the present disclosure shown in FIGS. 4a-b, drop down windows 410 activated from the toolbar 400 by a mouse click are dynamically generated based on the selected vehicle and the context. The features included in text on the menus 410 are process-related, and can be accompanied by buttons with icons 420 which are highlighted when the mouse is rolled over them (notice arrow over icon 420 or menu item 430). Either the graphic or the text can be clicked to activate the menu item 430. FIG. 4a shows dynamically generated menu items representing measurement features available for rear axle alignment. FIG. 4b shows dynamically generated menu items 430 representing measurement features available for front axle alignment.

Floating Window

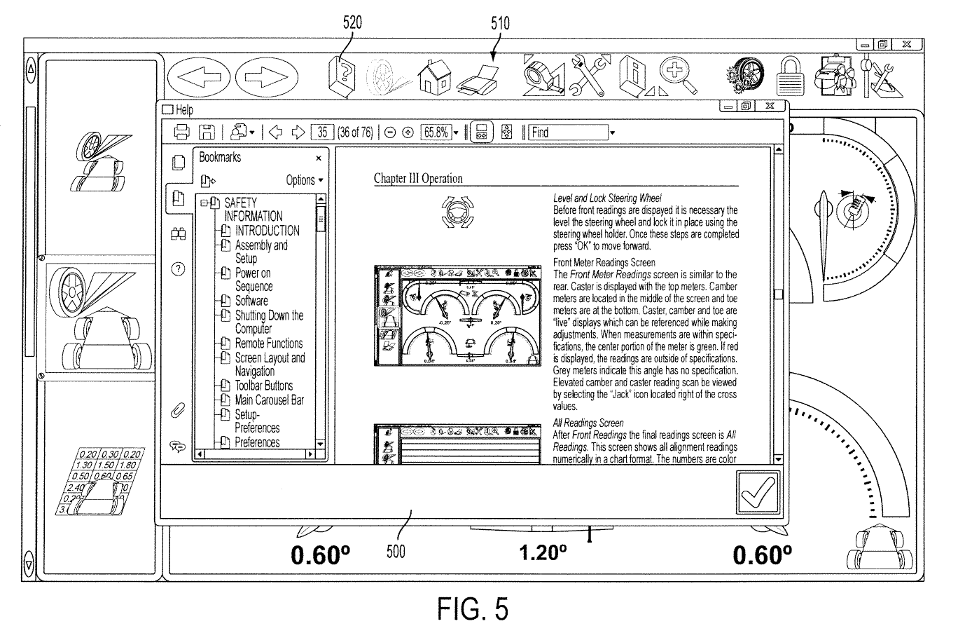

In certain embodiments shown in FIG. 5, a popup or floating window 500 floats over a page or window providing functionality for some quick action, while allowing a primary procedure to continue. The popup window 500 behaves like a sticky window which always stays on top. For example, a help video can play on the popup window 500, while the background alignment procedure continues. As shown in FIG. 5, a text-based tutorial is displayed in window 500 from the help menu by clicking the help icon 520 on the tool bar 510. As it shows the tutorial in the window, the user can continue performing the alignment procedure. Thus, the user sees instructions relating to how to perform an alignment while simultaneously performing the alignment. The popup window 500 can be any shape, it can be resizable, and can be dragged anywhere on the screen. This functionality is provided, for example, by the Popup Control of Windows Presentation Foundation (WPF), available from Microsoft of Redmond, Wash.

Transparent Popup Window Background

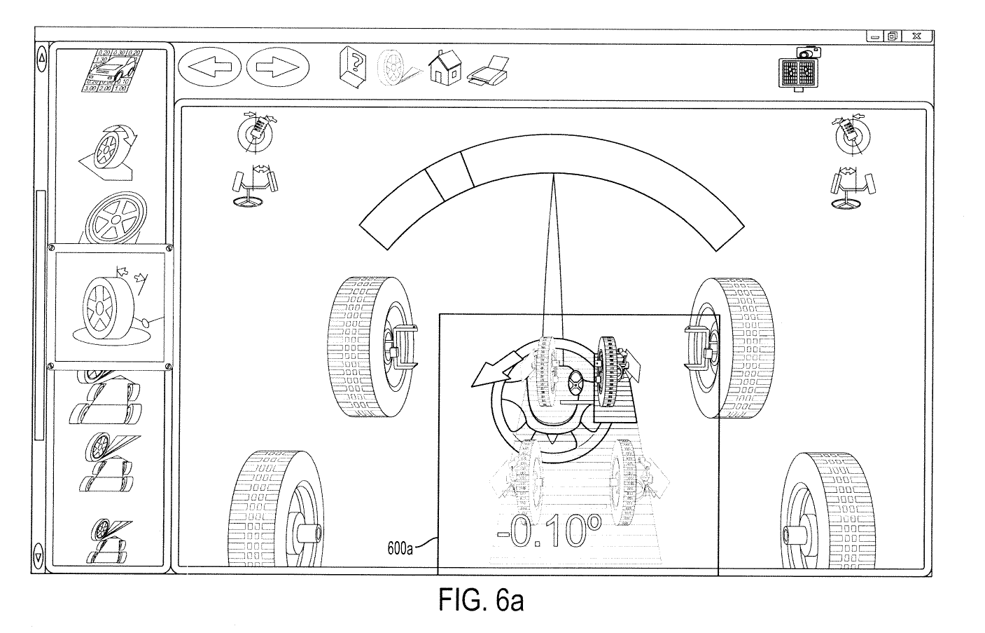

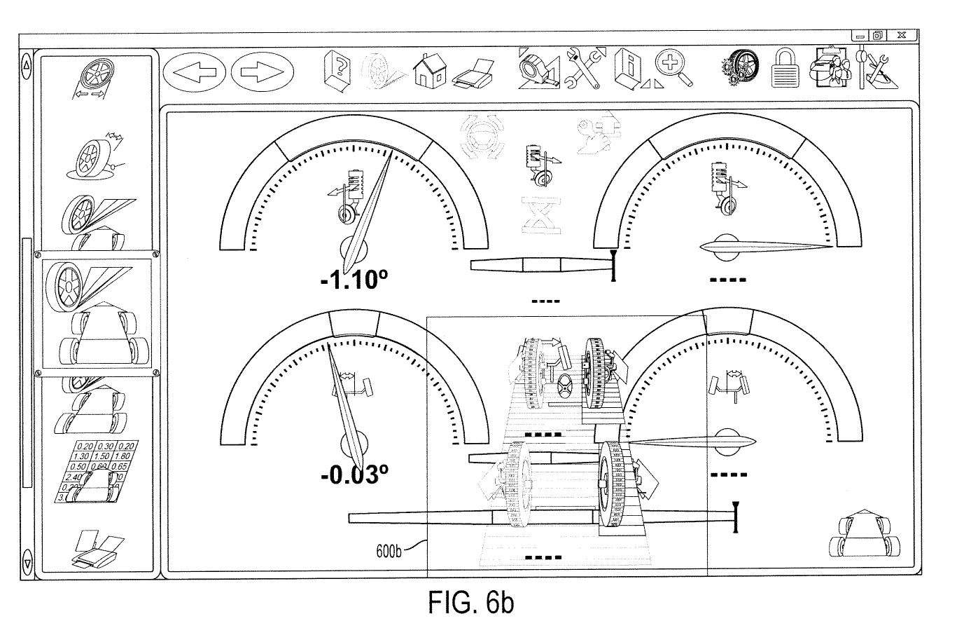

In certain embodiments, a popup window in an aligner graphic user interface is implemented as a transparent window, as by using WPF. WPF's ability to render an entire window with per-pixel transparency also enables WPF's anti-aliasing rendering to operate on a layered (i.e., popup) window, consequently resulting in high edge quality in such a rendering. Transparency can be set in the non-client area and in the child windows. The “non-client area” refers to the parts of the window that the windowing system normally renders for the application, such as the title bar, the resize edge, the menu bar, the scroll bars, etc. As shown in FIGS. 6a-b, an advantage of using a transparent window 600a, 600b as a popup is that the user is able to see what is happening behind the popup. Window transparency is set in XML by setting “AllowTransparency=true” and the background of the window as “Background={x:Null}.”

In still other embodiments, background colors can be changed; e.g., to other than black. A number of color options is provided for the user to select for the differently-colored background. The change of background can apply either to the entire application, or only to the selected screen.

Gradient Background Fill

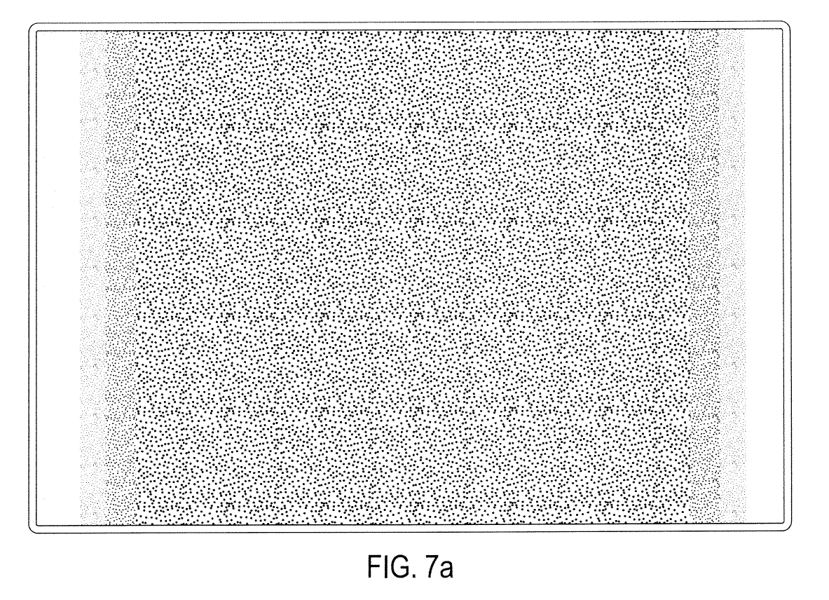

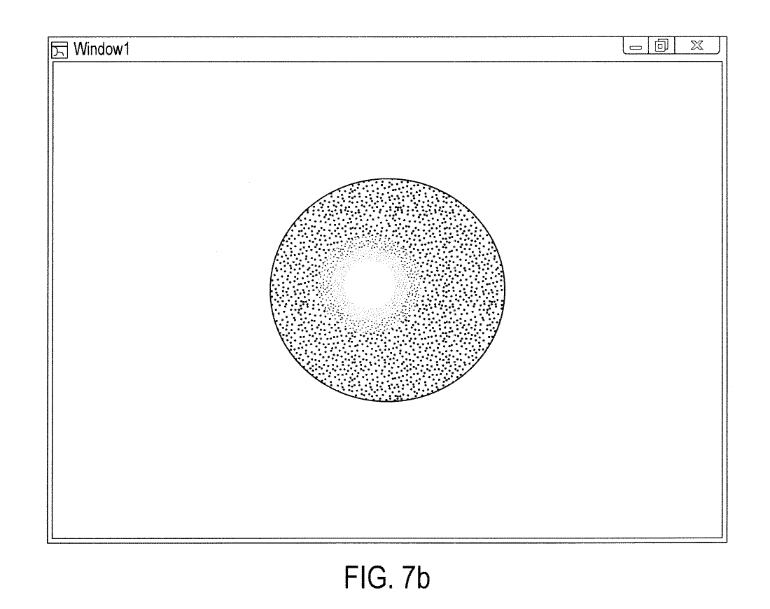

In certain embodiments of the disclosure, gradient background fill is used to achieve a three-dimensional appearance without wire frame 3D modeling in meters, backgrounds, etc. When used in the background, the outline can appear to have backlighting. If the values of the gradient are varied in real time, an object can appear to rotate without using a 3D wire frame. FIG. 7a is an example of a background gradient. Those skilled in the art will understand this effect is readily implemented in Extensible Application Markup Language (XAML) using the “LinearGradientBrush” function and assigning different colors and offsets to specific “GradientStop” attributes. FIG. 7b is an example of an object having a 3D look from using a gradient. Those skilled in the art will understand this effect is readily implemented in XAML using the LinearGradientBrush and RadialGradient Brush functions.

Dashboard Indicators

In certain embodiments, a display is implemented to inform the user about important and/or critical alignment related information. The disclosed display is analogous to the dashboard implementation of automobiles, wherein the check engine indicator, low oil indicator, high temperature indicator, traction indicator, etc. do not illuminate until needed to indicate the proper condition of the vehicle. However, the driver can still discern the outline of these indicators when they are not illuminated (although they do not need to pay attention to them until they illuminate). The disclosed aligner display screen implements this functionality as follows, using a well-known tool such as Visual Studio 2008, XAML, WPF, or C#. Other conventional toolkits (i.e., development environments) may be used to achieve similar effects.

In conventional alignment systems, indicators are placed on the screen or hidden on the screen. If the indicator is not active, the user is not aware that the indicator may pop up unless it has been previously experienced. For example, if the vehicle to be aligned does not have diagnostic charting information, no such icon appears on the display screen; but if the vehicle has diagnostic charting capabilities, an “iOBD” icon is displayed alerting the operator to a special condition. In other words, the indication is binary: either on or off.

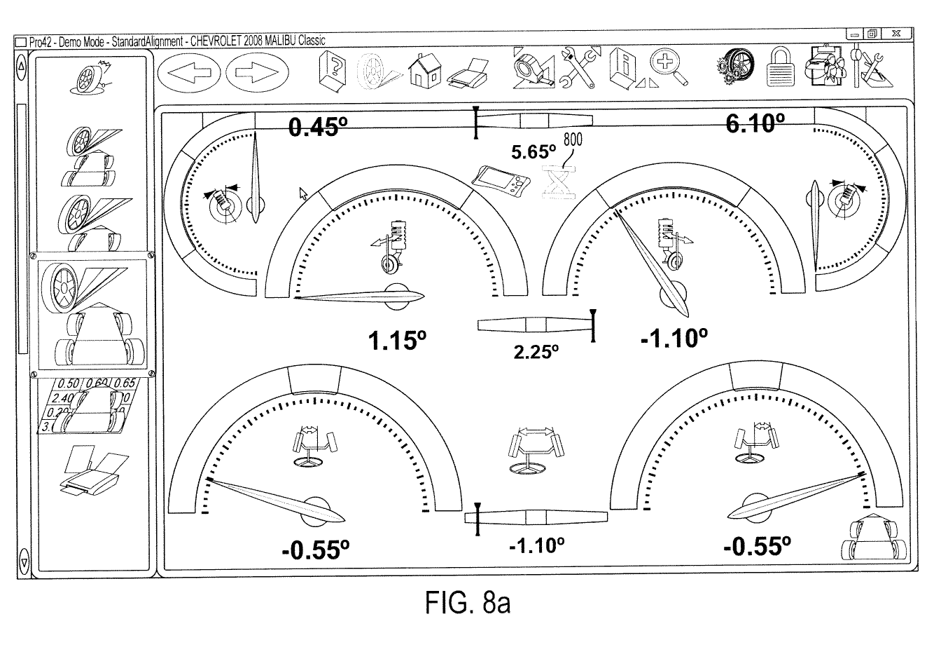

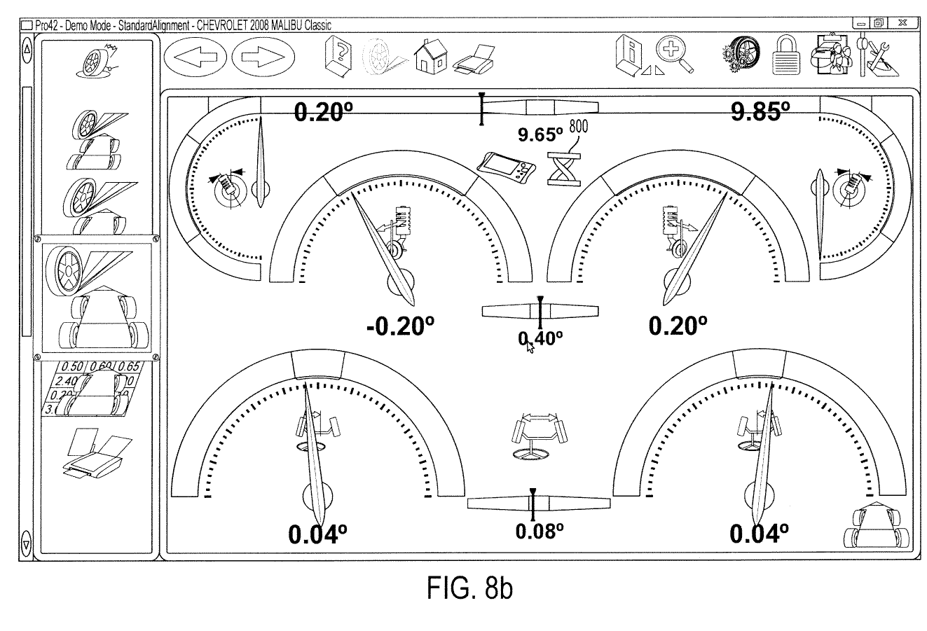

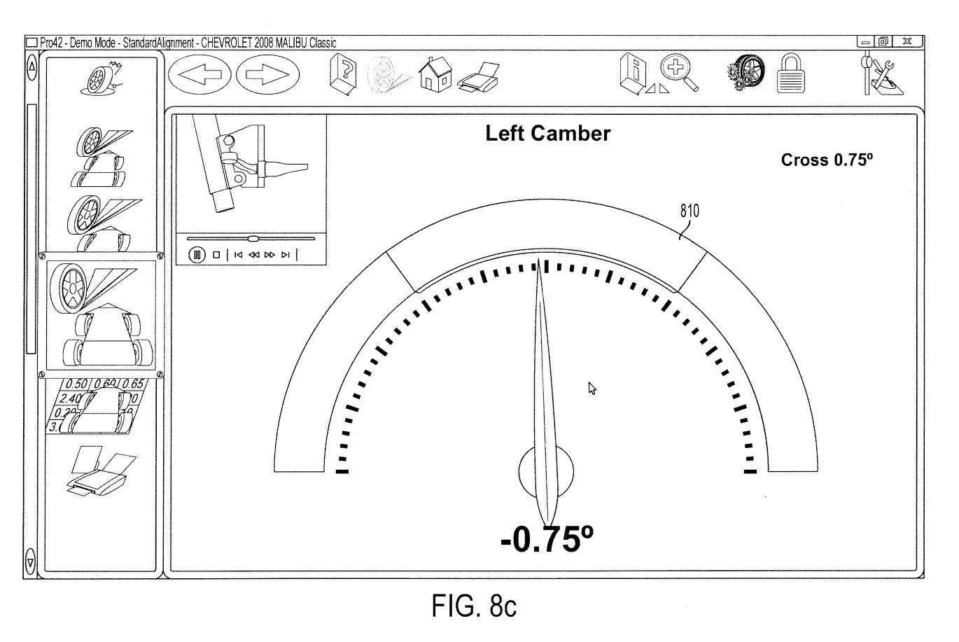

The present embodiment of the disclosure provides multiple implementations between on and off, wherein on=100% and off=0% opacity. For example, on a scale from 1.0 (100%) to 0.0 (0%), 0.4 is 40%. As shown in FIG. 8a, one can see the indicator 800, but its opacity has been reduced to 20%. However, when an appropriate condition exists, the opacity of the object 800 is set to 100% as shown in FIG. 8b. One indicator is illuminated and the other indicator is still visible, but at a reduced opacity.

These effects are achieved in a Windows environment by setting the opacity level of the desired displayed object. The opacity level is set based on detecting a condition for which the operator may need to be alerted. When not alerted, the operator knows the condition does not exist because the condition indicator is still on the screen in the “non-alert” illumination mode (i.e., that object is at a reduced opacity level).

For example, using C#:

Object.Opacity=1.0; //100% opaque OR Object.Opacity=0.2; //20% opaque

In a further embodiment, a meter display changes state when a reading is within specification, giving the user confidence the reading is within tolerance. In conventional alignment systems, an operator is alerted to certain vehicle conditions as being in or out of tolerance solely based on whether the needle on a meter display is in or out of a predetermined zone, such as a green zone. If the display's needle or other indicator is on the transition from red to green (out of tolerance or within tolerance), it is difficult to determine the condition.

In the disclosed embodiment, as shown in FIG. 8c, the meter's central zone 810 changes state and glows when within specification, to indicate the reading is within tolerance. This is accomplished, for example, by changing the bitmap effect for the object; in the present case, a meter. The C# code to implement the glow effect (referred to below as green glow) is as follows:

OuterGlowBitmapEffect ogbe=new OuterGlowBitmapEffect( );
Ogbe.GlowColor=Color.FromRGB(0,0xD0,0); //Green glow
Ogbe.GlowSize=25; //size of the glow
MeterObject.DitmapEffect=ogbe;
//To Unglow the meter object
MeterObject.BitmapEffect=null;

“True View” Screens

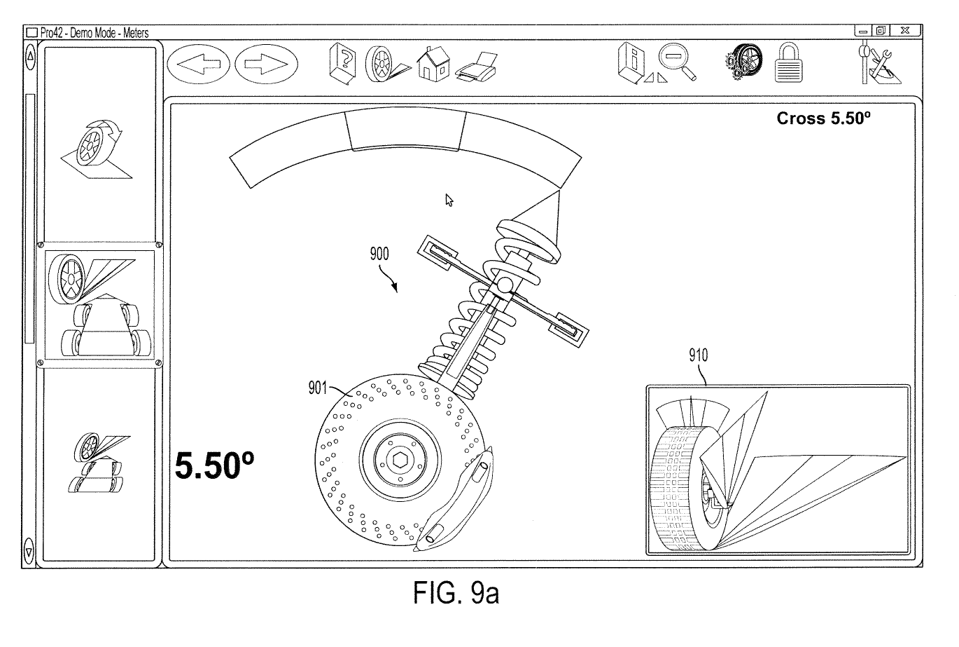

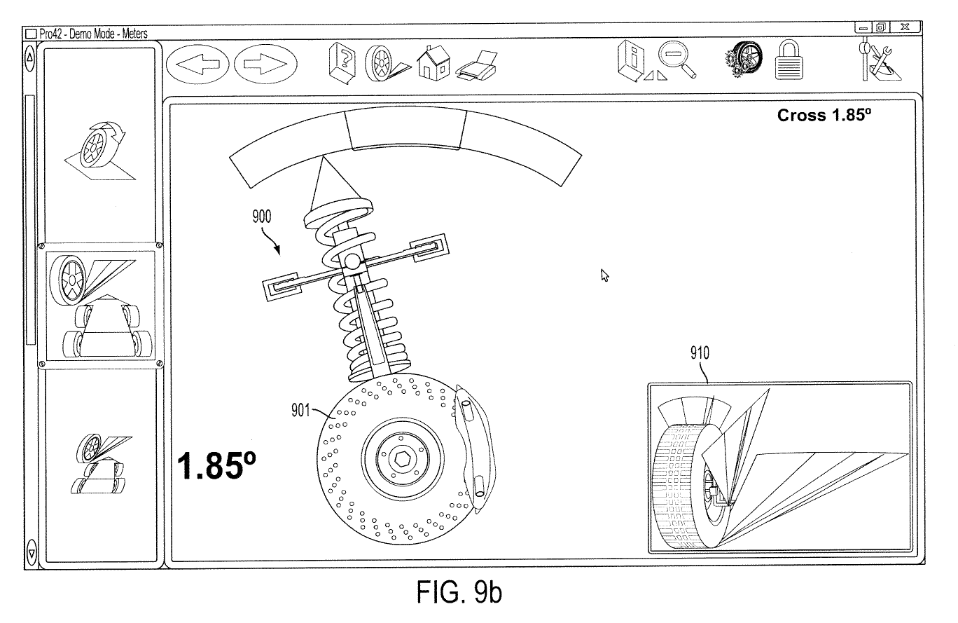

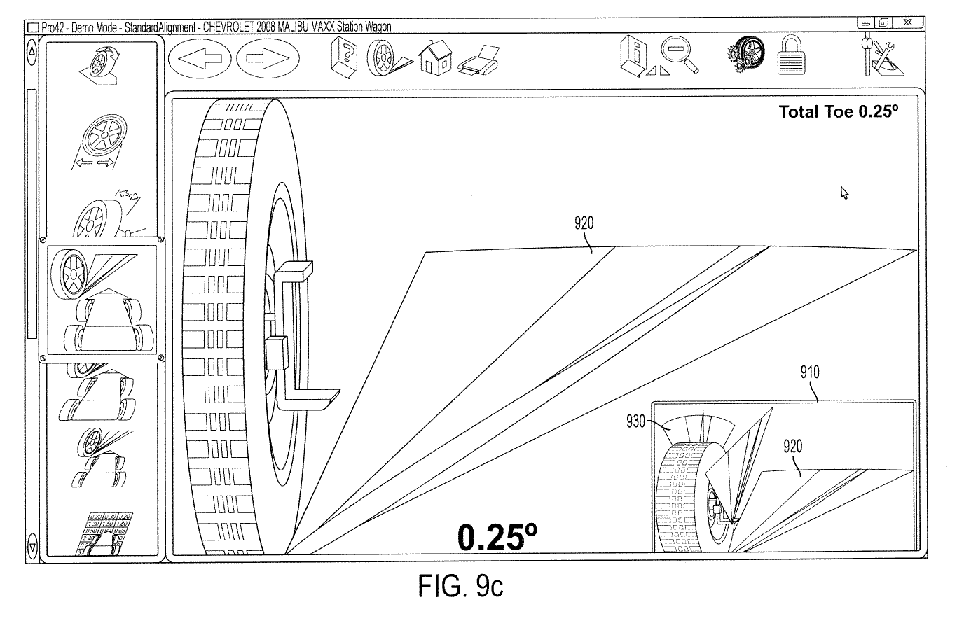

Conventional reading screens employ images such as a meter gauge having a needle indicating the current alignment reading, such as caster, camber, or toe. This reading is often relative to the manufacturer's specification for the vehicle being aligned. In certain embodiments of the disclosure, the needle indicator is replaced with a true representation of the angle being aligned, as shown in FIGS. 9a-b displaying the caster angle. The graphic representation 900 of the needle moves relative to the displayed alignment reading. FIG. 9b shows a different caster angle reading compared to FIG. 9a.

One way to implement this embodiment is to draw a 2-dimensional image such as assembly 900 such that it looks like a 3-dimensional object, as by using a conventional graphical design package such as Microsoft Expression Design 2 available from Microsoft. The rotation point is set at the desired point, such as at the center of the rotor 901. This is saved as a PMG-type file, and then the meter gauge is implemented in XAML code, setting the image source for the circular pointer needle to be the name of the 3-dimensional image. To enable the image needle to move to the correct value, C# code can be used to set the value in a conventional manner.

In further embodiments, when a reading (such as caster, camber, or toe) for a specific wheel is enlarged, an inset panel is displayed showing readings for all desired parameters. As shown in FIG. 9a, an inset 910 shows caster, camber, and toe readings. This display is useful to show how a change to one measured parameter affects other parameters. The inset 910 can be generated using 2-dimensional graphics positioned and/or transformed in a conventional manner to convey the appearance of three dimensionality.

In other embodiments, the user clicks on one of the gauges (readings) of the inset, and that reading is zoomed. Referring now to FIG. 9c, when the user clicks on the toe reading 920 of the insert 910, the toe 920 is zoomed. Likewise, clicking on the camber reading 930 of the inset 910 would result in the camber 930 being zoomed, etc.

Virtual Instrumentation

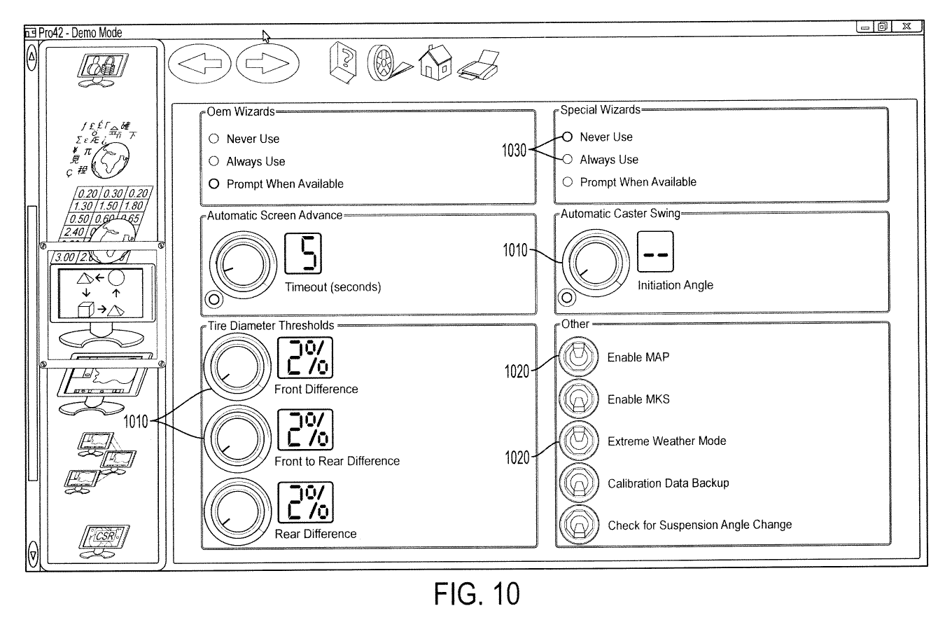

In certain embodiments, conventional Windows graphical user interface controls such as sliders, radio buttons, and buttons to change values are replaced with a virtual representation of physical knobs, switches, and lights, as shown in FIG. 10. Conventional controls are not intuitive, and require training for the user to understand and use them. The disclosed knobs 1010 in FIG. 10, which replaces a slider, intuitively communicates to the user that if they rotate a knob 1010, the value of its function will go up and down. A click sound can be added to the knobs 1010 to indicate that the function has been turned on or off. If the function value is simply a true/false or on/off, a virtual representation of a toggle switch 1020 with a click sound replaces the traditional radio button for improved ergonomics. Further, multiple choice radio buttons are replaced with interlinked virtual switches or virtual lighted buttons 1030. These controls are implemented, for example, using tools such as Actipro Software WPF Studio for WPF, available at www. ActiproSoftware.com.

Mouse Over Graphic Glow

In conventional user interfaces, the mouse pointer is pointed at an area on the screen containing, e.g., an icon, and a tooltip pops up to indicate the function of the screen area (e.g., “Home”, “Help”, “Print”, etc.). However the tooltip goes away in a few seconds. Disadvantageously, if the selection pointer is on the edge of two buttons, it is not readily apparent which function will be activated by pressing the mouse button.

In certain embodiments of the disclosure, a characteristic(s) of the item under the mouse pointer is changed. For example, an icon is changed to have a glow, a drop shadow, or other graphics effect; and/or to transform, be animated, vibrate, or emit a sound or other sensory perceptible stimuli. This provides the user more confidence that, when they press the mouse button or other entry device, the appropriate selection will be made.

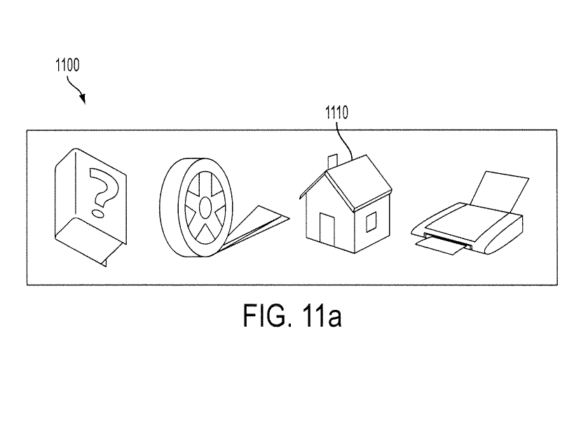

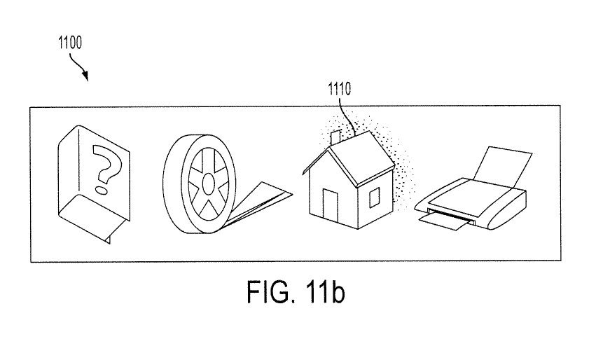

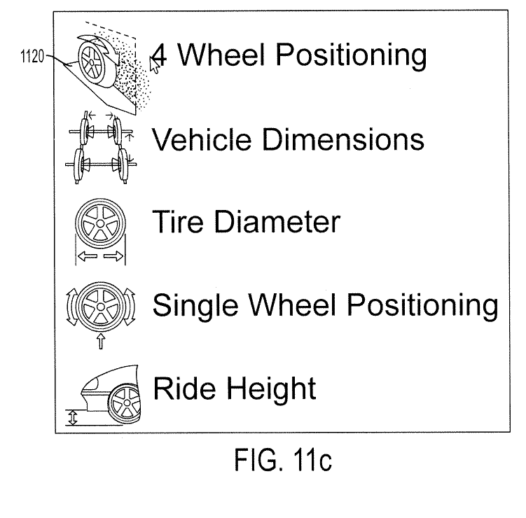

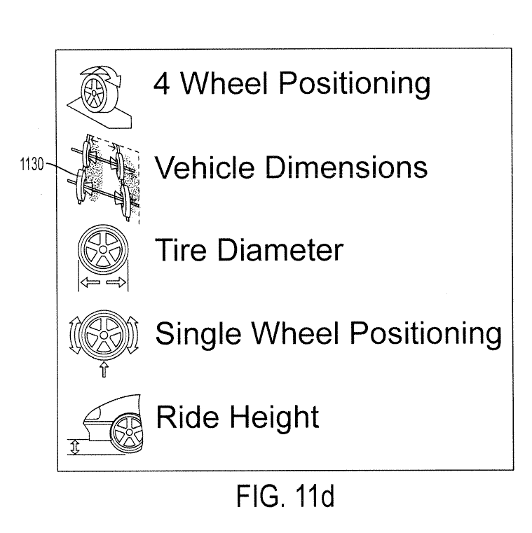

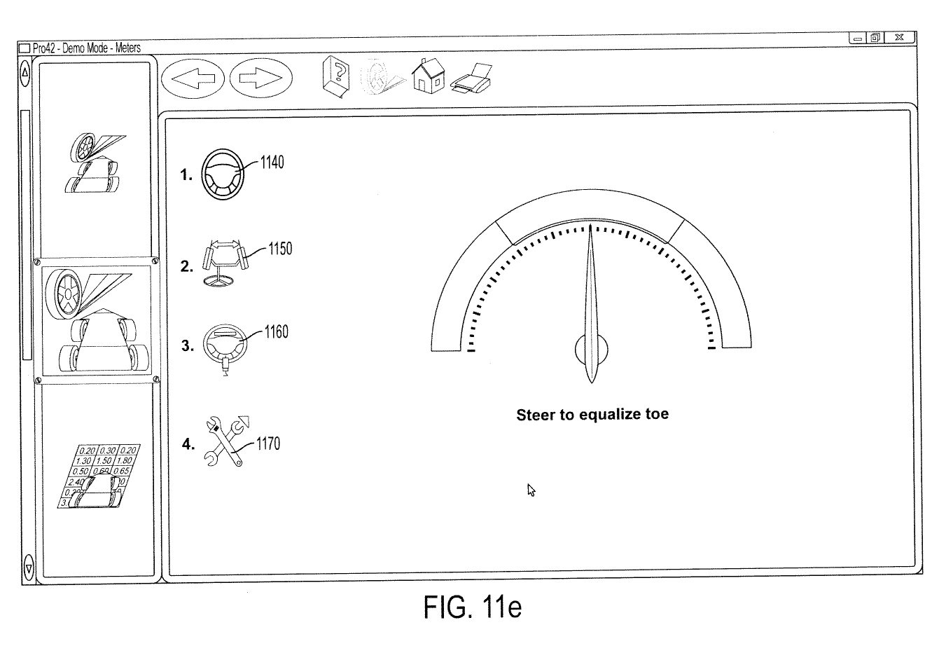

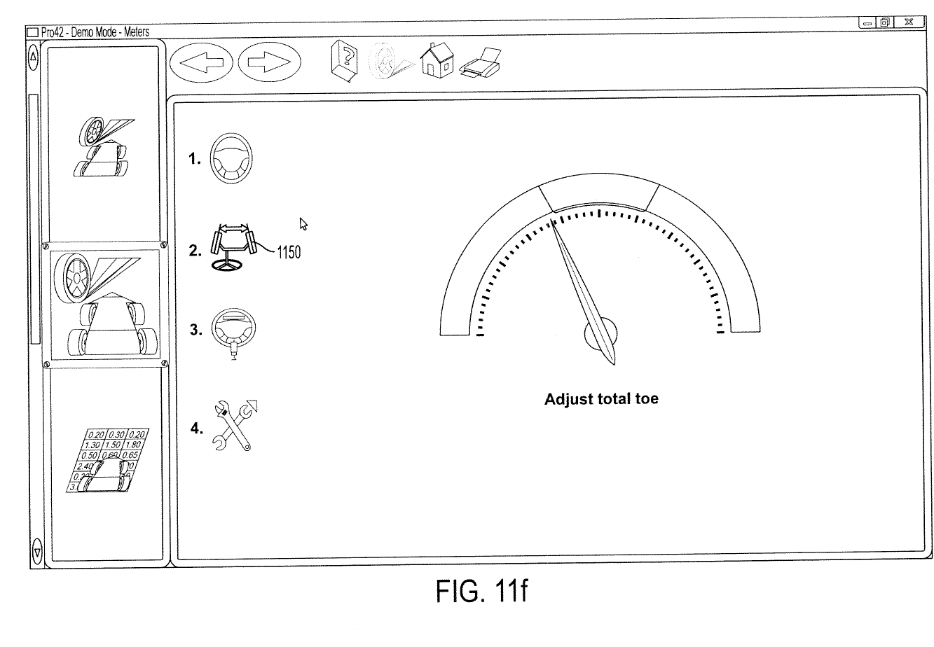

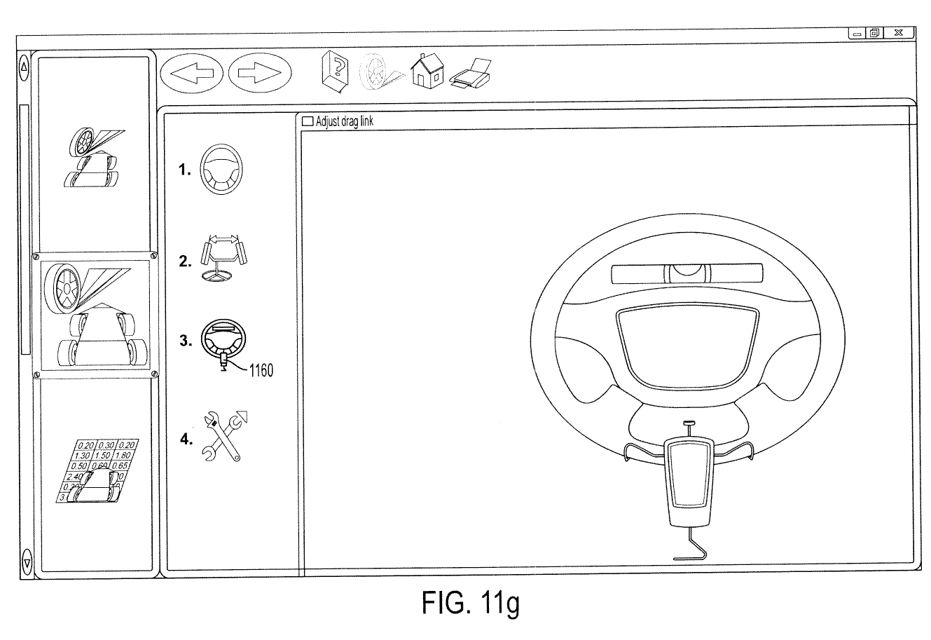

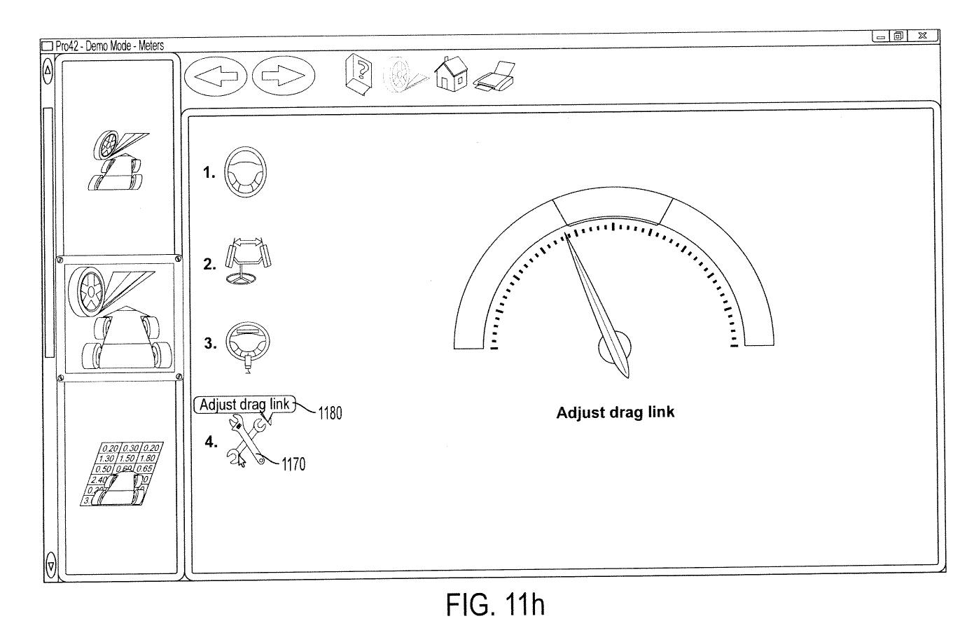

FIG. 11a shows a menu bar 1100 before the mouse pointer is moved over it (or it is otherwise selected). FIG. 11b shows the menu bar 1100 after the mouse pointer is moved over it, or it is selected. Note that the image 1110 is glowing and slightly rotated. These effects are achieved in a Windows environment by capturing the mouse-over event. For example, in XAML code capture the mouse entering area event and the mouse exiting area event using “MouseEnter” and “MouseLeave” functions. Similarly, in the C# code that supports XAML, the “TB_MouseEnter” and “TB_MouseLeave” functions are used.

In other embodiments, these graphic effects are used for items other than mouse pointer functions. Such effects are used to provide tactile feedback for keyboard navigation. For example, the screen of FIG. 11c is presented with the first item 1120 glowing and rotated. Upon pressing the down arrow key of the keyboard 130 (not shown in FIG. 11c), the screen of FIG. 11d is displayed, highlighting that the second item 1130 on the menu is selected. The up and down arrow keys are used to position the selection indicator to the desired item, and the enter key of the keyboard is then pressed to make the final selection. On a touch screen application, the same technique is used to show an item has been touched successfully. Sound or other sensory perceptible stimuli can optionally be used to present the operator a better user interface experience.

A further use of tactile feedback is to inform the user of where they are currently in a multiple-step procedure. FIGS. 11e-h show a drag link adjustment procedure user interface according to this embodiment. The screen of FIG. 11e shows item 1140 glowing with the item 1140 image set with an opacity of 1.0 (i.e., 100% opaque). All the other items 1150-1170 and associated images are set to a lower level opacity such as 0.2, or 20% opacity. By changing the opacity and glowing for each step, as shown in FIGS. 11f-h, the operator readily knows which step they are currently on, and sees the preceding and remaining steps (although they are set to a reduced opacity). Each of the steps also has tooltip help 1180 available, as shown in FIG. 11h. The tooltip 1180 pops up when the mouse pointer is hovered above the step's associated icon.

The opacity of the above-described items is readily set and changed in C# by getting the item's object reference and setting the desired opacity value. The glow of each item is set in the same manner as the mouse-over described above.

XSLT Transformation of TSB/TPMS Data in Vehicle Alignment

In other embodiments of the present disclosure, XSLT transformation is implemented within a vehicle alignment system. XSLT (XSL Transformations) is an XML-based language for transforming XML documents into other XML documents. The original document is not changed; rather, a new document is created based on the content of an existing one. The new document may be serialized output by the processor in standard XML syntax or in another format, such as Hypertext Markup Language (HTML) or plain text. XSLT is often used to convert XML data into HTML or XHTML documents for display as a web page. The transformation may happen dynamically either on the client or on the server, or it may be performed as part of the publishing process. XSLT is developed and maintained by the World Wide Web Consortium (W3C).

Modern automobiles contain onboard monitoring and control systems such as tire pressure monitoring systems (TPMS), which are electronic systems for monitoring the air pressure inside the vehicle's tires. When a vehicle's tires are rotated, the wheel location must be synchronized with the TPMS so it will provide an accurate indication of tire air pressure. Additionally, automobile manufacturers write and publish large amounts of documentation relating to servicing, repairing, and maintaining the vehicles they manufacture. A common method of publishing this information is by issuing technical service bulletins (TSB). Presenting this documentation in a relevant and efficient way during the servicing processes is a great advantage to the technicians and owners of service shops.

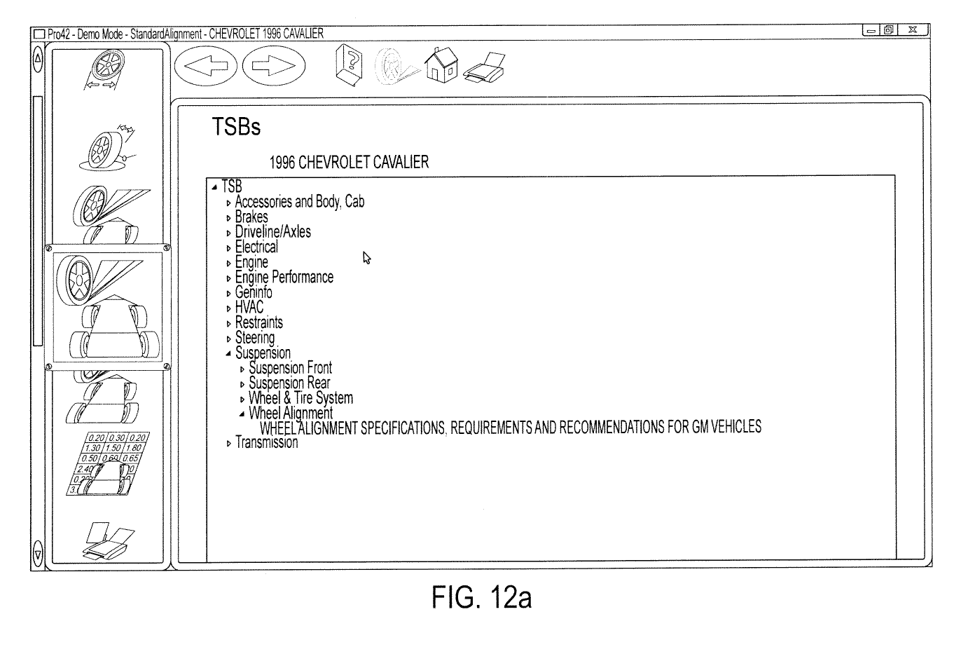

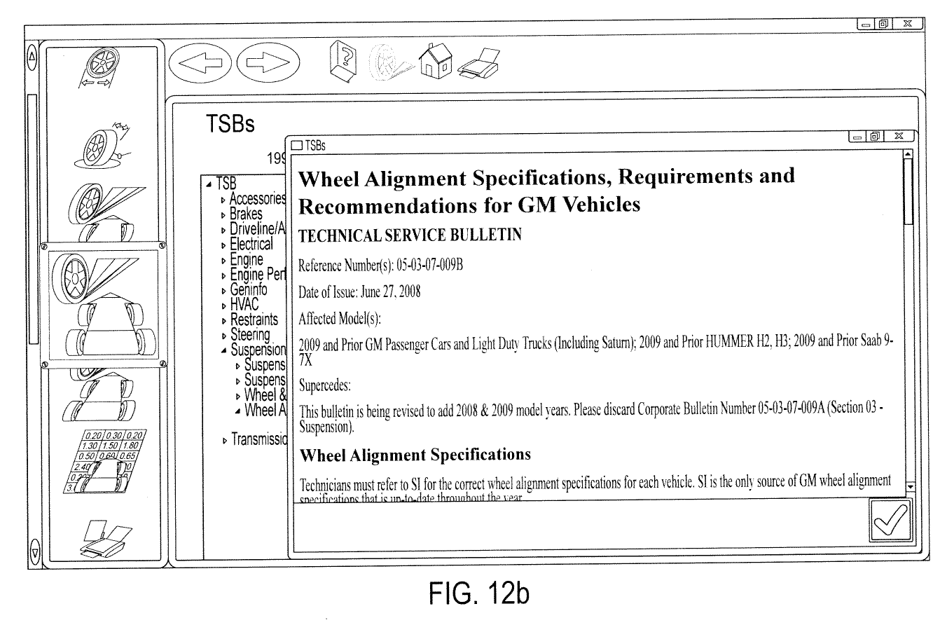

The disclosed alignment software facilitates and provides this information to the user. In one embodiment, TSB and TPMS data is stored locally or on a server as raw data in XML format. This raw data is dynamically transformed and converted into HTML for display within an embedded browser that is part of the aligner's user interface. An associated XSLT file is paired with the XML data, in a conventional manner, to perform the transformation from data to presentation as desired. An example is shown in FIG. 12a, wherein a user selects from a list of TSB articles presented in a tree control, and a subsequent HTML page of the selected article is displayed (see FIG. 12b).

XAML/WPF/Silverlight-Based Reports

According to the present disclosure, alignment summary reports are generated based on the calculations of measurement angles before and after adjustment, with reference to the manufacturer's specifications. The generated measurement angles are saved in an XML enabled format independent of the alignment system platform. The saved data in XML format is used to generate summary reports in XAML language. The XAML enabled data is capable of being rearranged and formatted so it can be arranged in various layouts according to the user. A sample report is shown in FIG. 13.

A well-known tool such as Microsoft Blend is used to lay out the report in XAML and to bind all the fields to XML. For example, a text box is inserted, the field is named, and properties are selected to set the margins and assign the styles. This disclosed technique is advantageous in that it is not limited to third party tools, and any developer who has XML and XAML knowledge can modify the reports. As those skilled in the art will understand, the reports can be viewed in an viewer which supports XAML and XPS formats (the reports also support XML Paper Specification (XPS) format). The reports can also be presented in WPF or Microsoft Silverlight, which enable generation of an application with a compelling user interface that is either stand-alone or browser-hosted.

VIN Scanning and Decoding for Wheel Alignment

A Vehicle Identification Number (VIN) is a unique number used by the automotive industry to uniquely identify individual vehicles. A standard VIN is 17 characters in length. Encoded is information regarding where the vehicle was manufactured, the make, model, and year of the vehicle, and a limited number of the vehicle's attributes. The last several digits include a sequential number to provide the uniqueness. The VIN is used by many auto-related businesses such as parts suppliers and insurance companies to facilitate marketing and sales efforts.

Vehicle alignment software typically uses a proprietary database containing alignment specifications provided by the vehicle manufacturers. In conventional wheel alignment systems, the VIN is typically manually entered in a customer data screen, and contains no connection to any vehicle databases. The process of selecting a vehicle includes manually selecting the vehicle from a complete and lengthy list arranged in a tree fashion.

In this embodiment of the disclosure, implementing VIN into the alignment software is accomplished by matching a VIN to the vehicles defined in the alignment database. A barcode scanner 150 (see FIG. 1) facilitates accurate entry of the VIN, which is then matched. A cross-reference table is used to facilitate the relationship between vehicles in the alignment database and the VIN data. Because specifications may vary based on vehicle attributes that are not encoded within a VIN, the cross-reference relationship may be one-to-many to the vehicle database. An example of such an attribute is wheel size.

In this embodiment, the VIN is entered using the keyboard 130 or barcode scanner 150 of system 100, and a database query is performed using the cross-reference table. If the VIN resolves to a single match, the alignment process automatically continues to a next step if desired. If the VIN matches to numerous entries in the specifications database, the user is given a very small subset to choose from to make a vehicle selection. Thus, this embodiment enables a faster and more accurate vehicle selection process that is easier to use.

Obfuscation

It has been possible for hackers to change the graphics of a user interface and present it as their own creation. Recently, with the advent of the .NET framework and just-in-time complying, it is possible to decompile a program and reverse engineer its contests to steal intellectual property. Certain embodiments of the present disclosure employ obfuscation to safeguard the above items by renaming symbols, adding extra symbols, dead code, unused branches, etc. After obfuscation, a decompiler will fail to produce readable source code that a computer hacker can use. One way to accomplish obfuscation is to use third party tools such as “dotfuscator” available at www.preemptive.com.

XML-Based Language Translations Using Unicode

In conventional user interfaces, all text is typically compiled as a resource in the executable code. To perform a human-language translation, the resource is extracted and the text translated to the desired language to create a new resource. A “satellite” data link layer driver (dll) is then generated from this new resource and loaded, thereby replacing the executables resource. Disadvantageously, the user is unable to make their own translations, since a specialized program is needed to generate satellite dlls, and new satellite dlls are required with every revision of the program (if any of the English-language text is revised, the translation(s) of the revised text is lost). Additionally, all languages are stored in their local text encoding, so unless the host PC is loaded with that locale, it might not be possible to display the text. Still further, the Windows operating system for different countries has different screen metrics, so when using the above-described satellite dll technique, the screen layout changes for each language as well.

These problems are addressed in certain disclosed embodiments by keeping all translations in XML files in Unicode, which files are easily edited by a text editor, as will be understood by those of skill in the art. Translations are loaded on the fly, and can be edited while the program is running. The translations are in Unicode, so they be displayed on any PC regardless of their locale, and screen metrics is not an issue. English is treated as a translation, so a phrase can change without affecting any other translations.

Web Cameras

In certain embodiments, web camera technology is used to take pictures of customers and vehicles, and to monitor the alignment rack as a drive-on aid. The picture(s) taken of the customer and/or vehicle are stored into a database with other customer information (e.g., name, address, etc.). When more than one web camera is connected to the alignment system's computer, the aligner user interface shows a list of all the available cameras in a drop down list. The user selects the camera whose image is to be shown on the screen. Images from multiple web cameras can also be displayed simultaneously in different areas of the screen. The integration of the webcam(s) is implemented, for example, using DirectShow and WPF in a conventional manner.

Those skilled in the art will understand that the above-described user interface elements are usable alone or in combination with each other as appropriate, even though every such combination is not explicitly set forth herein.

Computer hardware platforms may be used as the hardware platform(s) for one or more of the user interface elements described herein. The hardware elements, operating systems and programming languages of such computers are conventional in nature, and it is presumed that those skilled in the art are adequately familiar therewith to adapt those technologies to implement the graphical user interface essentially as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

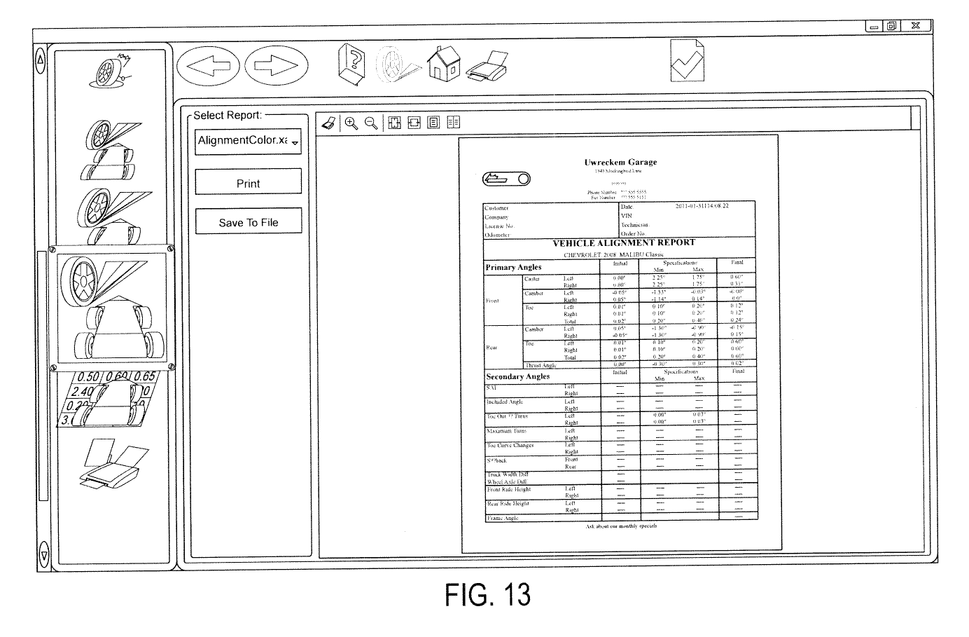

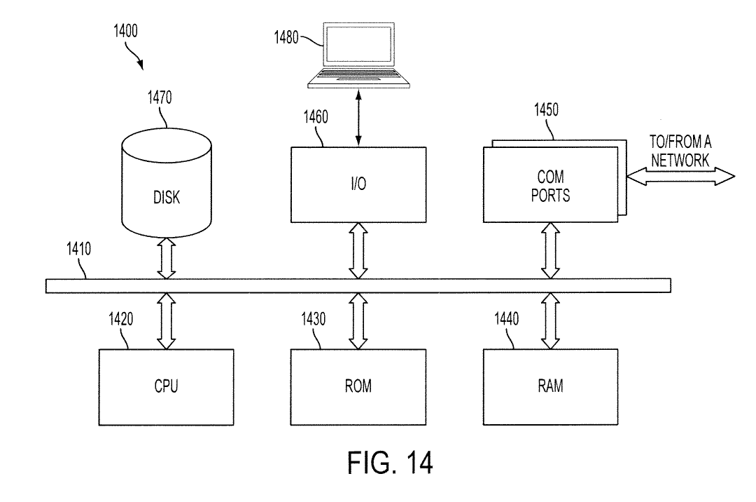

FIG. 14 provides a functional block diagram illustration of a computer hardware platform which includes user interface elements. The computer may be a general purpose computer or a special purpose computer. This computer 1400 can be used to implement any components of the graphical user interface as described herein. For example, the software tools for generating the carousel control and nested user interface elements can all be implemented on a computer such as computer 1400, via its hardware, software program, firmware, or a combination thereof. Although only one such computer is shown, for convenience, the computer functions relating to processing of the disclosed user interface may be implemented in a distributed fashion on a number of similar platforms, to distribute the processing load.

The computer 1400, for example, includes COM ports 1450 connected to and from a network connected thereto to facilitate data communications. The computer 1400 also includes a central processing unit (CPU) 1420, in the form of one or more processors, for executing program instructions. The exemplary computer platform includes an internal communication bus 1410, program storage and data storage of different forms, e.g., disk 1470, read only memory (ROM) 1430, or random access memory (RAM) 1440, for various data files to be processed and/or communicated by the computer, as well as possibly program instructions to be executed by the CPU. The computer 1400 also includes an I/O component 1460, supporting input/output flows between the computer and other components therein such as user interface elements 1480. The computer 1400 may also receive programming and data via network communications.

Hence, aspects of the methods of generating the disclosed graphical user interface, e.g., the carousel control and nested controls, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on a PC or server. In addition, the user interface and its components as disclosed herein can be implemented as a firmware, firmware/software combination, firmware/hardware combination, or a hardware/firmware/software combination.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present teachings. However, it should be recognized that the present teachings can be practiced without resorting to the details specifically set forth. In other instances, well known processing structures have not been described in detail, in order not to unnecessarily obscure aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A computer-implemented method for performing a plurality of vehicle service activities, the method comprising:
displaying, on a first portion of a display unit, a plurality of visual images, each visual image corresponding to a respective one of the vehicle service activities, arranged along a movement path;
receiving a first selection of a first visual image included in the visual images;
displaying, on a second portion of the display unit, a user interface for performing the vehicle service activity corresponding to the first visual image, in response to the first selection;
displaying the visual indication for the first visual image that the first visual image was selected, in response to the first selection; and
moving at least one of the plurality of visual images along the movement path in response to the first selection.

2. The method of claim 1, further comprising:
receiving a first instruction to move the plurality visual images along the movement path; and
moving the plurality of visual images along the movement path in response to the first instruction.

3. The method of claim 1, wherein
the plurality of vehicle service activities are arranged in a sequence; and
the visual images are arranged along the movement path in an order corresponding to the sequence in which their respective vehicle service activities are arranged.

4. The method of claim 3 further comprising:
displaying a first user interface element for advancing to a next vehicle service activity;
displaying a second user interface for advancing to a previous vehicle service activity;
receiving a second selection of the first user interface element;
identifying a second vehicle service activity arranged in the sequence of vehicle service activities immediately after the vehicle service activity corresponding to the selected first visual image, in response to the second selection;
displaying, on the second portion of the display unit, a user interface for performing the second vehicle service activity, and continuing to display the plurality of visual images in the first portion of the display unit, in response to the second selection;
displaying, on the first portion of the display unit, a visual indication that the second vehicle service activity is being performed, in response to the second selection;
receiving a third selection of the second user interface element;
identifying a third vehicle service activity arranged in the sequence of vehicle service activities immediately before the vehicle service activity corresponding to the selected second visual image, in response to the second selection; and
displaying, on the second portion of the display unit, a user interface for performing the third vehicle service activity, and continuing to display the plurality of visual images in the first portion of the display unit, in response to the third selection.

5. The method of claim 1, further comprising:
displaying a visual indication for a second visual image included in the visual images indicating that the vehicle service activity corresponding to the second visual image has been completed.

6. The method of claim 1, wherein
the visual indication includes one of (a) overlaying an image over a visual image, or (b) an illumination effect for a visual image.

7. The method of claim 1, further comprising:
scaling the plurality of visual images such that the first visual image is displayed larger than the other visual images included in the plurality of visual images and/or for each of the other visual images there is an inverse relationship between a scale applied to a visual image and the distance of the other visual image from the first visual image, in response to the first selection.

8. The method of claim 1, comprising:
displaying, on a third portion of the display unit, a toolbar comprising a plurality of toolbar visual images;
receiving a toolbar selection of one of the plurality of toolbar visual images; and
displaying, in a drop down window from the selected toolbar visual image, a list of menu items representing features responsive to the user interface on the second portion of the display unit.

9. The method of claim 1, comprising:
displaying, on a third portion of the display unit, a toolbar comprising a plurality of toolbar visual images;
receiving a toolbar selection of one of the plurality of toolbar visual images; and
displaying video or text-based information in a floating window over the second portion of the display unit, responsive to the toolbar selection.

10. The method of claim 1, comprising displaying a pop up window over the user interface on the second portion of the display unit, wherein the pop up window is transparent such that the user interface is visible behind the pop up window.

11. The method of claim 1, comprising displaying a background of the first or second portion of the display unit having a background gradient fill.

12. The method of claim 1, comprising displaying an object appearing in the first or second portion of the display unit having a gradient fill such that the object has a three dimensional appearance.

13. The method of claim 1, comprising;
detecting a condition for which a user is to be alerted; and
setting an opacity level of an object of the user interface on the second portion of the display unit based on the condition.

14. The method of claim 13, comprising setting the opacity of the object at a reduced level when the condition is not detected.

15. The method of claim 1, wherein the user interface on the second portion of the display unit includes a meter display for displaying a reading, comprising changing the appearance of a portion of the meter display when the reading is within a predetermined range.

16. The method of claim 1, comprising displaying, in the user interface on the second portion of the display unit, a meter having a needle indicator for indicating a reading of a first vehicle wheel alignment parameter;
wherein the needle indicator includes a graphic representation of the first parameter, and the graphic representation moves relative to the reading.

17. The method of claim 16, comprising displaying, in the user interface on the second portion of the display unit, a graphic representation of the first vehicle wheel alignment parameter reading and a second vehicle wheel alignment parameter reading.

18. The method of claim 17, comprising:
receiving a selection of one of the first and second vehicle wheel alignment parameter readings of the graphic representation; and
displaying an enlarged graphic representation of the selected reading.

19. The method of claim 1, comprising displaying, in the user interface on the second portion of the display unit, a virtual representation of at least one of a physical knob control, a switch control, and a lighted button control.

20. The method of claim 1, comprising:
displaying, on the display unit, a plurality of grouped visual images proximal to each other, each visual image indicating a function;
receiving a selection of one of the plurality of grouped visual images; and
changing the appearance of the selected visual image, responsive to the selection.

21. The method of claim 20, wherein changing the appearance of the selected visual image comprises at least one of causing the image to be animated, vibrate, have a glow, have a drop shadow, or emit a sound.

22. The method of claim 1, comprising:
displaying, on the user interface on the second portion of the display unit, a plurality of process step images, each process step image corresponding to a sequential step in a process being performed, the plurality of process step images including a current process step image corresponding to a process step currently being performed; and
setting an opacity of the current process step image to a visibly different level than the opacity of all the other process step images.

23. The method of claim 1, comprising:
storing data relating to the vehicle service activity in XML format;
converting the data to HTML; and
displaying the converted data on the user interface on the second portion of the display unit.

24. The method of claim 1, comprising:
displaying, on the user interface on the second portion of the display unit, a first user interface element for listing a plurality of items;
receiving a first selection of the first user interface element;
displaying the first user interface element and a listing of the plurality of items in response to the first selection, wherein each item is presented with a second user interface element and a third user interface element;
receiving a second selection for the second user interface element presented for a first item included in the plurality of items;
displaying at least a portion of the listing of the plurality of items and a fourth user interface element with contents relating to the first item, in response to the second selection;
receiving a third selection for the third user interface element presented for the first item included in the plurality of items;
communicating that the first item was selected in response to the third selection.

25. A vehicle service system for performing a vehicle service activity comprising a series of service activates, the system comprising:
a processor; and
a computer readable medium having computer-executable instructions that, when executed by the processor, cause the computer system to:
display, on a first portion of a display unit, a plurality of visual images, each visual image corresponding to a respective one of the vehicle service activities, arranged along a movement path;
receive a first selection of a first visual image included in the visual images;
display, on a second portion of the display unit, a user interface for performing the vehicle service activity corresponding to the first visual image, in response to the first selection;
display the visual indication for the first visual image that the first visual image was selected, in response to the first selection; and
move at least one of the plurality of visual images along the movement path in response to the first selection.

26. The system of claim 25, wherein the computer readable medium has computer-executable instructions that, when executed by the processor, cause the computer system to:
receive a first instruction to move the plurality visual images along the movement path; and
move the plurality of visual images along the movement path in response to the first instruction.

27. The system of claim 25, wherein the plurality of vehicle service activities are arranged in a sequence, and the visual images are arranged along the movement path in an order corresponding to the sequence in which their respective vehicle service activities are arranged.

28. The system of claim 25, wherein the computer readable medium has computer-executable instructions that, when executed by the processor, cause the computer system to:
display a first user interface element for advancing to a next vehicle service activity;
display a second user interface for advancing to a previous vehicle service activity;
receive a second selection of the first user interface element;
identify a second vehicle service activity arranged in the sequence of vehicle service activities immediately after the vehicle service activity corresponding to the selected first visual image, in response to the second selection;
display, on the second portion of the display unit, a user interface for performing the second vehicle service activity, and continuing to display the plurality of visual images in the first portion of the display unit, in response to the second selection;
display, on the first portion of the display unit, a visual indication that the second vehicle service activity is being performed, in response to the second selection;
receive a third selection of the second user interface element;
identify a third vehicle service activity arranged in the sequence of vehicle service activities immediately before the vehicle service activity corresponding to the selected second visual image, in response to the second selection;
display, on the second portion of the display unit, a user interface for performing the third vehicle service activity, and continuing to display the plurality of visual images in the first portion of the display unit, in response to the third selection.

29. The system of claim 25, wherein the computer readable medium has computer-executable instructions that, when executed by the processor, cause the computer system to:
display a visual indication for a second visual image included in the visual images indicating that the vehicle service activity corresponding to the third visual image has been completed.

30. The system of claim 25, wherein
the visual indication includes one of (a) overlaying an image over a visual image, or (b) an illumination effect for a visual image.

31. The system of claim 25, wherein the computer readable medium has computer-executable instructions that, when executed by the processor, cause the computer system to:
scale the plurality of visual images such that the first visual image is displayed larger than the other visual images included in the plurality of visual images and/or for each of the other visual images there is an inverse relationship between a scale applied to a visual image and the distance of the other visual image from the second visual image, in response to the first selection.

32. A computer readable medium having instructions for performing a vehicle service activity comprising a series of service steps that, when executed by a computer system, cause the computer system to:
display, on a first portion of a display unit, a plurality of visual images, each visual image corresponding to a respective one of the vehicle service activities, arranged along a movement path;
receive a first selection of a first visual image included in the visual images;
display, on a second portion of the display unit, a user interface for performing the vehicle service activity corresponding to the first visual image, in response to the first selection;
display the visual indication for the first visual image that the first visual image was selected, in response to the first selection; and
move at least one of the plurality of visual images along the movement path in response to the first selection.

33. The computer-readable medium of claim 32, having computer-executable instructions that, when executed by the processor, cause the computer system to:
receive a first instruction to move the plurality visual images along the movement path; and
move the plurality of visual images along the movement path in response to the first instruction.

34. The computer-readable medium of claim 32, wherein the plurality of vehicle service activities are arranged in a sequence, and the visual images are arranged along the movement path in an order corresponding to the sequence in which their respective vehicle service activities are arranged.

35. The computer-readable medium of claim 32, having computer-executable instructions that, when executed by the processor, cause the computer system to:
display a first user interface element for advancing to a next vehicle service activity;
display a second user interface for advancing to a previous vehicle service activity;
receive a second selection of the first user interface element;
identify a second vehicle service activity arranged in the sequence of vehicle service activities immediately after the vehicle service activity corresponding to the selected first visual image, in response to the second selection;
display, on the second portion of the display unit, a user interface for performing the second vehicle service activity, and continuing to display the plurality of visual images in the first portion of the display unit, in response to the second selection;
display, on the first portion of the display unit, a visual indication that the second vehicle service activity is being performed, in response to the second selection;
receive a third selection of the second user interface element;
identify a third vehicle service activity arranged in the sequence of vehicle service activities immediately before the vehicle service activity corresponding to the selected second visual image, in response to the second selection;
display, on the second portion of the display unit, a user interface for performing the third vehicle service activity, and continuing to display the plurality of visual images in the first portion of the display unit, in response to the third selection.

36. The computer-readable medium of claim 32, having computer-executable instructions that, when executed by the processor, cause the computer system to:
display a visual indication for a second visual image included in the visual images indicating that the vehicle service activity corresponding to the second visual image has been completed.

37. The computer-readable medium of claim 32, wherein
the visual indication includes one of (a) overlaying an image over a visual image, or (b) an illumination effect for a visual image.

38. The computer-readable medium of claim 32, having computer-executable instructions that, when executed by the processor, cause the computer system to:
scale the plurality of visual images such that the second visual image is displayed larger than the other visual images included in the plurality of visual images and/or for each of the other visual images there is an inverse relationship between a scale applied to a visual image and the distance of the other visual image from the second visual image, in response to the first selection.
